(19) United States
(12) Patent Application Publication
(10) Pub. No.: US 2026/0086236 A1
(43) Pub. Date: Mar. 26, 2026

(54) SYSTEM AND METHOD OF AUTOMATED TRAINING OF AN AIRBORNE LIDAR BATHYMETRY MACHINE LEARNING SYSTEM USING MULTIBEAM ECHO SOUNDING INFORMATION

(71) Applicant: FNV IP B.V., Leidschendam (NL)

(72) Inventors: Charles LAPOINTE, Ottawa (CA); Arjan MOOIJ, Doha (QA); Ian VOORHIES, Houston, TX (US); Wendt WITHERS, Lafayette, LA (US)

(73) Assignee: FNV IP B.V., Leidschendam (NL)

(21) Appl. No.: 18/893,714

(22) Filed: Sep. 23, 2024

(51) Int. Cl. G01S 17/894; G01S 7/4865

(52) U.S. Cl. CPC G01S 17/894; G01S 7/4865

(57) ABSTRACT

Described are systems and techniques for processing airborne lidar bathymetry (ALB) data. A plurality of lidar frames can be obtained, each associated with a respective measurement swath within a surveyed area and a first coordinate system corresponding to an ALB system. A plurality of multibeam echo sounder (MBES) bathymetry data points can be obtained, indicative of seabed locations within the surveyed area, and associated with a second coordinate system corresponding to the surveyed area. A subset of corresponding MBES data points can be determined for the respective measurement swath of each lidar frame based on projection between the first and second coordinate systems, and can be used to generate annotation information indicative of seabed locations within each lidar frame. A machine learning network can be trained to identify seabed bathymetry features within input lidar frames, using training data comprising the plurality of lidar frames and the generated annotation information.

### FIELD

Aspects of the present disclosure generally relate to airborne lidar bathymetry and the automated and/or semi-automated mapping and rendering of map data. For example, aspects of the present disclosure are related to systems and techniques for automating training of an airborne lidar bathymetry machine learning system using training data from multi beam echo sounding data.

### BACKGROUND

Geospatial images, representing a portion of the earth's surface, may be used to identify features of interest. Features of interest can include, but are not limited to, commercially exploitable features or geohazards. Geospatial images (e.g., also referred to as geospatial mapping data or geospatial data) can include bathymetry data associated with the measurement of the depth of water and/or other features of interest in oceans, seas, or lakes, among various other bodies of water. For example, bathymetry data can be used to determine underwater topography associated with subsea regions, coastal regions, near-shore regions, etc.

In some cases, the effective identification and mapping of underwater topography (e.g., subsea geohazards) can be critical to safe and economically efficient subsea operations, including oil and gas operations. Subsea geospatial images (including bathymetry data) may be collected in many different forms, including, for example, multibeam echosounder (MBES) bathymetry data, datasets from spectral sensors, satellite imagery data, airborne light detection and ranging (LIDAR) bathymetry (ALB) data, optical images from autonomous or remote-operated vehicles, etc. While large amounts of subsea geospatial data can be generated using various surveying techniques, the identification and mapping of features of interest is a critical and often rate-limiting step in data image processing and analysis. Accordingly, there is a need for improved techniques for analyzing and processing geospatial data.

Machine learning is capable of analyzing tremendously large datasets at a scale that continues to increase. Using various machine learning techniques and frameworks, it is possible to analyze datasets to extract patterns and correlations that may otherwise have never been noticed when subject to human analysis alone. Using carefully tailored data inputs a machine learning system can be manipulated to learn a desired operation, function, or pattern. However, this training process can be complicated by the fact that the machine learning system's inner functionality remains largely opaque to the human observer and analytical results from machine learning techniques may be highly input or method dependent. For instance, training datasets can easily be insufficient, biased or too small resulting in faulty or otherwise insufficient training. As a result, there is a need to provide effective automated mapping utilizing machine learning systems, networks, and/or models.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In one illustrative example, a method can include: obtaining a plurality of lidar frames each comprising a respective plurality of lidar measurement points obtained along a respective measurement swath within a surveyed area and associated with a first coordinate system corresponding to an airborne light detection and ranging (lidar) bathymetry (ALB) system; obtaining multibeam echo sounder (MBES) bathymetry data comprising a plurality of MBES data points indicative of locations on a seabed within the surveyed area, the plurality of MBES data points associated with a second coordinate system corresponding to the surveyed area and different from the first coordinate system; performing projection between the first coordinate system corresponding to the ALB system and the second coordinate system corresponding to the surveyed area, to thereby determine a subset of corresponding MBES data points corresponding to the respective measurement swath for each lidar frame of the plurality of lidar frames; generating annotation information indicative of a ground truth location of the seabed within each lidar frame of the plurality of lidar frames, the annotation information generated based on the subset of corresponding MBES data points and using the first coordinate system corresponding to the ALB system; and training a machine learning network to identify seabed bathymetry features within input lidar frames, wherein the training is performed using training data comprising the plurality of lidar frames and the generated annotation information for each lidar frame of the plurality of lidar frames.

In some aspects, the first coordinate system includes: a first coordinate dimension corresponding to a beam angle associated with one or more lidar scans of the ALB system, wherein different values of the beam angle are associated with different points along the respective measurement swath; and a second coordinate dimension corresponding to a range from the ALB system, wherein different values of the range are associated with different distances from the ALB system.

In some aspects, the second coordinate system is a Cartesian coordinate system, a geographic coordinate system, or a spherical coordinate system for a geographic region including the surveyed area.

In some aspects, the respective measurement swath is a swath line extending between a first location within the surveyed area and a second location within the surveyed area, and wherein the respective plurality of lidar measurements are on the swath line.

In some aspects, performing the projection to determine the subset of corresponding MBES data points for each respective lidar frame of the plurality of lidar frames includes: calculating a georeferenced start and end coordinate for the respective measurement swath of the respective lidar frame, wherein the georeferenced start and end coordinates are determined within the second coordinate system; generating a plurality of calculated points along a line between the georeferenced start and end coordinates within the second coordinate system, wherein the plurality of calculated points represent the lidar measurement swath in the second coordinate system, the plurality of calculated points adjusted based on refraction information determined corresponding to refraction of one or more lidar pulses at an air-water interface; and comparing the plurality of calculated points to the plurality of MBES data points to determine a set of closest MBES data points for each one of the plurality of calculated points.

In some aspects, generating the annotation information comprises: interpolating between the set of closest MBES data points determined for each one of the plurality of calculated points representing the lidar measurement swath in the second coordinate system, to thereby generate an interpolated MBES data point lying on the lidar measurement swath; and generating the annotation information to include the interpolated MBES data point as a ground truth location of a seabed bathymetry feature within the lidar frame, wherein the interpolated MBES data point is transformed from the second coordinate system to the first coordinate system using the determined refraction information corresponding to the refraction of the one or more lidar pulses at a water surface associated with the seabed within the surveyed area.

In some aspects, the subset of corresponding MBES data points for the lidar frame comprises the sets of closest MBES data points determined for the calculated points representing the lidar measurement swath in the second coordinate system.

In some aspects, the set of closest MBES data points includes MBES data points within a configured threshold distance from the calculated point.

In some aspects, the set of closest MBES data points includes at least a first MBES data point having a shortest distance to the calculated point and a second MBES data point having a second shortest distance to the calculated point, the first and second MBES data points included in the MBES bathymetry data.

In some aspects, a number of points included in the plurality of calculated points is equal to a number of horizontal pixels in the lidar frame.

In some aspects, the plurality of calculated points is generated based on one or more of a configured separation interval or a configured maximum quantity.

In some aspects, the respective lidar frame is obtained by the ALB system at a particular time; and the georeferenced start and end coordinates are calculated based on a measured position of the ALB system at the particular time when the respective lidar frame was obtained by the ALB system, wherein the measured position of the ALB system is determined within the second coordinate system.

In some aspects, the position of the ALB system in the second coordinate system is determined using one or more of a Global Navigation Satellite System (GNSS) or Global Positioning System (GPS) receivers coupled to the ALB system, or an inertial navigation system (INS) coupled to the ALB system.

In some aspects, each lidar frame of the plurality of lidar frames comprises a rasterized frame of lidar bathymetry waveforms obtained along a linear measurement swath within the surveyed area.

In some aspects, each lidar frame of the plurality of lidar frames includes at least a first subset of lidar measurement points corresponding to a water surface feature along the respective measurement swath within the surveyed area, and a second subset of lidar measurement points corresponding to a seabed bathymetry feature along the respective measurement swath within the surveyed area; and training the machine learning network to identify seabed bathymetry features comprises training the machine learning network to identify the second subset of lidar measurement points within input lidar frames.

In another illustrative example, a system is provided. The system includes at least one memory and at least one processor coupled to the at least one memory and configured to: obtain a plurality of lidar frames each comprising a respective plurality of lidar measurement points obtained along a respective measurement swath within a surveyed area and associated with a first coordinate system corresponding to an airborne light detection and ranging (lidar) bathymetry (ALB) system; obtain multibeam echo sounder (MBES) bathymetry data comprising a plurality of MBES data points indicative of locations on a seabed within the surveyed area, the plurality of MBES data points associated with a second coordinate system corresponding to the surveyed area and different from the first coordinate system; perform projection between the first coordinate system corresponding to the ALB system and the second coordinate system corresponding to the surveyed area, to thereby determine a subset of corresponding MBES data points corresponding to the respective measurement swath for each lidar frame of the plurality of lidar frames; generate annotation information indicative of a ground truth location of the seabed within each lidar frame of the plurality of lidar frames, the annotation information generated based on the subset of corresponding MBES data points and using the first coordinate system corresponding to the ALB system; and train a machine learning network to identify seabed bathymetry features within input lidar frames, wherein the training is performed using training data comprising the plurality of lidar frames and the generated annotation information for each lidar frame of the plurality of lidar frames.

In some aspects, to perform the projection to determine the subset of corresponding MBES data points for each respective lidar frame of the plurality of lidar frames, the at least one processor is configured to: calculate a georeferenced start and end coordinate for the respective measurement swath of the respective lidar frame, wherein the georeferenced start and end coordinates are determined within the second coordinate system; generate a plurality of calculated points along a line between the georeferenced start and end coordinates within the second coordinate system, wherein the plurality of calculated points represent the lidar measurement swath in the second coordinate system, and wherein one or more of the start and end coordinate and the plurality of calculated points are adjusted between the first and second coordinate systems based on refraction compensation information corresponding to one or more lidar pulses refracting at a water surface within the surveyed area; and compare the plurality of calculated points to the plurality of MBES data points to determine a set of closest MBES data points for each one of the plurality of calculated points.

In some aspects, to generate the annotation information, the at least one processor is configured to: interpolate between the set of closest MBES data points determined for each one of the plurality of calculated points representing the lidar measurement swath in the second coordinate system, to thereby generate an interpolated MBES data point lying on the lidar measurement swath; and generate the annotation information to include the interpolated MBES data point as a ground truth location of a seabed bathymetry feature within the lidar frame.

In another illustrative example, a method is provided, the method comprising: obtaining a plurality of lidar frames associated with an airborne light detection and ranging (lidar) bathymetry (ALB) system, each lidar frame of the plurality of lidar frames associated with a respective measurement swath within a surveyed area; generating a plurality of features corresponding to each lidar frame of the plurality of lidar frames; and processing the plurality of features corresponding to each lidar frame using a trained ALB segmentation machine learning network, wherein processing the plurality of features using the trained ALB segmentation machine learning network includes performing inference to generate one or more segmentation masks indicative of predicted seabed feature locations detected in each lidar frame, and wherein the trained ALB segmentation machine learning network is trained using ground truth seabed feature location annotation information determined from multibeam echo sounder (MBES) bathymetry data.

In another illustrative example, a non-transitory computer-readable storage medium comprising instructions stored thereon which, when executed by at least one processor, causes the at least one processor to: obtain a plurality of lidar frames each comprising a respective plurality of lidar measurement points obtained along a respective measurement swath within a surveyed area and associated with a first coordinate system corresponding to an airborne light detection and ranging (lidar) bathymetry (ALB) system; obtain multibeam echo sounder (MBES) bathymetry data comprising a plurality of MBES data points indicative of locations on a seabed within the surveyed area, the plurality of MBES data points associated with a second coordinate system corresponding to the surveyed area and different from the first coordinate system; perform projection between the first coordinate system corresponding to the ALB system and the second coordinate system corresponding to the surveyed area, to thereby determine a subset of corresponding MBES data points corresponding to the respective measurement swath for each lidar frame of the plurality of lidar frames; generate annotation information indicative of a ground truth location of the seabed within each lidar frame of the plurality of lidar frames, the annotation information generated based on the subset of corresponding MBES data points and using the first coordinate system corresponding to the ALB system; and train a machine learning network to identify seabed bathymetry features within input lidar frames, wherein the training is performed using training data comprising the plurality of lidar frames and the generated annotation information for each lidar frame of the plurality of lidar frames.

In another illustrative example, an apparatus is provided, the apparatus comprising: means for obtaining a plurality of lidar frames each comprising a respective plurality of lidar measurement points obtained along a respective measurement swath within a surveyed area and associated with a first coordinate system corresponding to an airborne light detection and ranging (lidar) bathymetry (ALB) system; means for obtaining multibeam echo sounder (MBES) bathymetry data comprising a plurality of MBES data points indicative of locations on a seabed within the surveyed area, the plurality of MBES data points associated with a second coordinate system corresponding to the surveyed area and different from the first coordinate system; means for performing projection between the first coordinate system corresponding to the ALB system and the second coordinate system corresponding to the surveyed area, to thereby determine a subset of corresponding MBES data points corresponding to the respective measurement swath for each lidar frame of the plurality of lidar frames; means for generating annotation information indicative of a ground truth location of the seabed within each lidar frame of the plurality of lidar frames, the annotation information generated based on the subset of corresponding MBES data points and using the first coordinate system corresponding to the ALB system; and means for training a machine learning network to identify seabed bathymetry features within input lidar frames, wherein the training is performed using training data comprising the plurality of lidar frames and the generated annotation information for each lidar frame of the plurality of lidar frames.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 3 illustrates an example of a bathymetry waveform segmentation task performed using a segmentation machine learning network, in accordance with some examples;

FIG. 4 illustrates an example of an annotated frame of bathymetry data, in accordance with some examples;

FIG. 5 illustrates an example architecture that can be used to train a bathymetry waveform segmentation machine learning network, in accordance with some examples;

FIG. 6A is a diagram illustrating an example of measurements performed using an airborne lidar bathymetry (ALB) system with a push-broom (e.g., linear) lidar scanning configuration, in accordance with some examples;

FIG. 6B is a diagram illustrating an example refraction scenario for an incident light wave striking an air-water interface such as the surface of a body of water, in accordance with some examples;

FIG. 7 is a diagram illustrating an example of an annotated frame of bathymetry data including topography feature annotations, water surface feature annotations, and seabed (e.g., bathymetry) feature annotations, in accordance with some examples;

FIG. 8 is a diagram illustrating an example of ALB training data annotation information generated for seabed (e.g., bathymetry) feature locations using multibeam echo sounder (MBES) bathymetry data, in accordance with some examples;

FIG. 9 is a flow diagram illustrating an example of a process for processing frames of lidar and/or ALB data, in accordance with some examples; and

FIG. 10 is a block diagram illustrating an example of a computing system for implementing certain embodiments of the present technology, according to embodiments of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

### Overview

Systems, apparatuses, processes (also referred to as methods), and computer-readable media (collectively referred to as “systems and techniques”) are described herein that can be used to provide automated training and/or training data generation (e.g., training data annotation information, training data labels, etc.) for an airborne lidar bathymetry (ALB) machine learning system, where the automated training and/or training data generation for the ALB machine learning system is implemented using multibeam echo sounding (MBES) information. For example, the systems and techniques can automatically generate ALB segmentation training data based on using MBES data as a source of ground truth labeling information for bathymetry features that can be detected in ALB data. The bathymetry features can correspond to features and/or locations on or of the seabed (or other floor or bottom surface of a body of water, etc.). MBES data can be obtained based on performing one or more MBES surveying or mapping operations for the body of water, and can comprise a plurality of MBES data points that are delivered in an x, y, z coordinate space, or other geographic coordinate system. Each MBES data point can correspond to a seabed surface location or a location of other bathymetric features within the body of water.

Airborne lidar bathymetry (ALB) is a remote sensing technique that uses one or more light detection and ranging (lidar) sensors, scanners, systems, etc., mounted to an airplane or other airborne vehicle. The airborne lidar(s) can be used to measure the depth and topography of water bodies (e.g., bathymetry), as well as the topography of the water surface and/or surrounding shoreline areas adjacent to the body of water. ALB systems can be used for the rapid, large-scale mapping of coastal areas, rivers, lakes, and various other shallow water environments. As the aircraft or other airborne vehicle flies over the survey area (e.g., the water body and surrounding land or shoreline areas of interest, etc.), the ALB system can emit rapid pulses of laser light towards the surveyed area. The laser pulses can reflect off of one or more surfaces within the surveyed area. For example, a laser pulse may reflect off of a terrain feature or other land-based topography, may reflect off of the water surface, and/or may reflect off of the seabed (e.g., the bottom or floor of the body of water). The ALB system can measure the round trip time (RTT) for each laser pulse to travel to a target within the surveyed area and reflect back to the ALB sensor(s). Based on the time measurement or RTT determined for each reflected laser pulse, the ALB system can be used to calculate a range (e.g., distance) from the ALB system to the target.

The difference in return times between a water surface reflection and the seabed reflection can be used to determine the water depth at a given location. The ALB system can be attached to or included in an aircraft or other airborne vehicle, as noted above. Position and orientation information can be determined using one or more sensors associated with the aircraft, and can be used to localize each lidar return to a particular location or coordinate within the surveyed area. For example, the aircraft or airborne vehicle can include one or more positioning sensors or positioning systems (e.g., a global positioning system (GPS), a global navigation satellite system (GNSS), an inertial navigation system (INS), a dead reckoning navigation system, a visual odometry system, a celestial navigation system, a beacon-based navigation system, a laser-based navigation system, and/or a magnetic navigation system, etc.), which can be used to determine the corresponding position of the aircraft, and therefore the ALB system, at the time each ALB measurement is taken. The aircraft or airborne vehicle can additionally include one or more orientation sensors or orientation systems (e.g., accelerometers, gyroscopes, inertial sensors, magnetic sensors, etc.) that can be used to determine the corresponding orientation of the aircraft, and therefore the ALB system, at the time each ALB measurement is taken.

ALB data and/or ALB measurements can be obtained as range-angle data, where each ALB measurement (e.g., each lidar return or reflected laser pulse) is characterized by a beam angle of the emitted laser pulse from the lidar, and a calculated range (e.g., distance) from the lidar to the target based on the measured RTT to receive the reflection. In some examples, the range-angle data of the ALB data or measurements can be associated with a range-angle coordinate system, where a horizontal axis corresponds to a scan angle of incidence along a measurement swath of the lidar (e.g., with a single “scan” comprising a plurality of lidar pulses emitted at different scan angles of incidence (also referred to as beam angle) along a single line representing the measurement swath), and where a vertical axis corresponds to the calculated range or distance to the target. In some aspects, based on the range/distance calculation being based on the RTT or elapsed time between emitting a pulse and receiving a corresponding reflection of the pulse, the range-angle coordinate system may also be referred to as a time-angle coordinate system.

As noted above, MBES data can be used as a source of ground truth bathymetry information indicative of the true locations of the seabed surface for a body of water, although MBES data is obtained and/or delivered in a x, y, z or other geographic coordinate system that is different from the range-angle or time-angle coordinate system used by the ALB system and lidar measurement scan frames. There is a need for systems and techniques that can be used to map between a first coordinate system corresponding to ALB data and measurements, and a second coordinate system corresponding to MBES bathymetry data. Based on mapping between the ALB time-angle coordinate system and the MBES x, y, z coordinate system, MBES bathymetry data can be used to automatically generate annotated or labeled training data for training a segmentation machine learning network to detect or predict the location(s) of the seabed and other bathymetry features within the native time-angle coordinate space of an ALB system or the lidar(s) included within an ALB system.

In one illustrative example, the systems and techniques described herein can be used for the automated training of an airborne lidar bathymetry machine learning system using multibeam echo sounding information. For example, a plurality of lidar frames can be obtained for a surveyed area. Each lidar frame can include a plurality of lidar measurement points that are obtained along a measurement swath within the surveyed area. Different lidar measurement points along the same measurement swath can correspond to laser/lidar pulses that are emitted at the same time as one another, with different beam angles or scan angles of incidence. The lidar frame and the plurality of lidar measurement points represented within the lidar frame can be associated with a first coordinate system corresponding to an ALB system. For example, the first coordinate system can be an angle-time coordinate system, also referred to as an angle-distance or angle-range coordinate system, as noted previously above. In some aspects, the plurality of lidar frames can be obtained from and/or using an ALB system. In some examples, the plurality of lidar frames can be obtained from a data storage device, for instance in examples where the disclosed systems and techniques are implemented after the ALB survey is performed rather than concurrently with or during the performance of the ALB survey, etc.

MBES bathymetry data can additionally be obtained for the same surveyed area that is associated with the plurality of lidar frames. In some cases, the MBES survey and ALB survey may be performed with a close temporal proximity to one another, to reduce or minimize the differences in topography and/or bathymetry that may emerge over longer periods of time separation between the MBES survey of an area and the ALB survey of the same area. In some examples, the temporal separation between the MBES survey and the ALB survey can be on the order of one or more days, or one or more weeks, etc. The MBES bathymetry data can comprise a plurality of MBES data points that are each indicative of respective locations on a seabed within the surveyed area. As noted previously above, the plurality of MBES data points can be associated with a second coordinate system that corresponds to the surveyed area, and is different from the first coordinate system that corresponds to the ALB system. For instance, the plurality of MBES data points can be associated with a cartesian coordinate system, a geographic coordinate system, a spherical coordinate system, etc.

The systems and techniques can be used to perform projection between the first coordinate system corresponding to the ALB system (e.g., the time-angle or range-angle coordinate system) and the second coordinate system corresponding to the MBES bathymetry data (e.g., the x, y, z coordinate system). Based on projecting between the respective data points of the lidar frames in the ALB coordinate system and the respective data points of the MBES bathymetry data in the MBES coordinate system, the systems and techniques can be used to thereby determine a subset of corresponding MBES data points that map to or match the respective measurement swath for each lidar frame of the plurality of lidar frames. The corresponding subset of MBES data points mapped to or identified for a given measurement swath of a lidar frame can be used to automatically generate annotation information indicative of a ground truth location of the seabed within each lidar frame. The annotation information can be generated from the MBES data points of the subset identified for the lidar measurement swath, and/or can be generated from one or more interpolated MBES data points that are calculated to better match to the lidar measurement swath of the given lidar frame. A segmentation machine learning network can subsequently be trained to identify seabed bathymetry features within input lidar frames, where the training is performed using training data comprising the plurality of lidar frames and the generated annotation information determined for each lidar frame from the corresponding subset of MBES data points and/or interpolated MBES data points.

### EXAMPLE EMBODIMENTS

Image semantic segmentation is a task of generating segmentation results for a frame of image data. For example, semantic segmentation can be performed for a frame of image data such as a still image or photograph. In some aspects, semantic segmentation can be performed for a frame of geospatial data, or other types of data that can be represented in a visual form. For example, semantic segmentation can be performed for frames of geospatial data comprising bathymetry waveforms, as will be described in greater depth below. Segmentation results can include one or more segmentation masks generated to indicate one or more locations, areas, and/or pixels within a frame of image data that belong to a given semantic segment (e.g., a particular object or feature, class of objects or features, etc.). For example, each pixel of a segmentation mask can include a value indicating a particular semantic segment (e.g., a particular object/feature, class of objects/feature, etc.) to which each pixel belongs. In some examples, the value associated with each pixel of a segmentation mask can be a probability of the pixel belonging to a given semantic segment.

In some examples, features can be extracted from an image frame and used to generate one or more segmentation masks for the image frame based on the extracted features. In some cases, machine learning can be used to generate segmentation masks based on the extracted features. For example, a convolutional neural network (CNN) can be trained to perform semantic image segmentation by inputting into the CNN many training images and providing a known output (or label) for each training image. The known output for each training image can include one or more ground-truth segmentation masks corresponding to a given training image. In some cases, image segmentation can be performed to segment image frames into segmentation masks based on an object classification scheme (e.g., the pixels of a given semantic segment all belong to the same classification or class). For example, one or more pixels of an image frame can be segmented into classifications such as human, hair, skin, clothes, house, bicycle, bird, background, etc.

In one illustrative example, when semantic segmentation is performed for an input comprising one or more frames of geospatial data (e.g., bathymetry data, airborne lidar bathymetry (ALB) data, etc.), a given input frame can be segmented into segmentation masks based on a feature detection scheme that corresponds to different types of surfaces represented in the bathymetry data. For example, an input bathymetry waveform can be segmented into a water surface mask, a seabed mask, a topographic feature mask, etc.

In some examples, a segmentation mask can include a first value for pixels that belong to a first classification, a second value for pixels that belong to a second classification, etc. In other examples, separate segmentation masks can be generated for the different classifications. In some examples, a segmentation mask can additionally, or alternatively, include one or more classifications for a given pixel. Instance segmentation can be performed to further classify (e.g., segment) pixels that are identified as belonging to one of the semantic classifications. For example, pixels identified as belonging to a water surface classification can be further segmented, using instance segmentation, into sub-classifications associated with the water surface classification. Sub-classifications associated with the water surface classification can include, but are not limited to, buoys, vessels, platforms, etc. Pixels identified as belonging to a “buoy” or other sub-classification can be included in a semantic segment (e.g., mask) associated with the “buoy” sub-classification and can also be included in a different semantic segment (e.g., mask) associated with the larger, “water surface” classification.

Segmentation masks can be used to apply one or more processing operations to a frame of input data (e.g., such as image data, geospatial data, bathymetry waveforms, etc.). For example, high-resolution mapping data, such as point cloud-based mapping data, can be generated by segmenting one or more bathymetry waveforms into one or more segmentation masks that separate the various features represented in the bathymetry waveform (e.g., water surface features, seabed features, topographic features, etc.).

The accuracy and quality of subsequent processing operations that use semantic segmentation masks can often depend on the underlying accuracy and quality of the semantic segmentation mask. For example, if a segmentation mask does not accurately identify the pixels in an input frame or image that represent a given feature, subsequent feature-specific processing operations that are performed based on the inaccurate segmentation mask can yield low quality or noisy results. In other words, an inaccurate segmentation mask corresponding to a given feature or classification may either be overinclusive or underinclusive relative to the actual or ground-truth pixels that represent the given feature in the input data frame. For example, an overinclusive segmentation mask may be inaccurate based on including additional pixels that do not belong to the given feature/classification. Similarly, an underinclusive segmentation mask may be inaccurate based on including only a portion of the pixels of the input data frame that correctly belong to the given feature/classification, while incorrectly omitting others.

Various aspects of the present disclosure will be described below with respect to the figures.

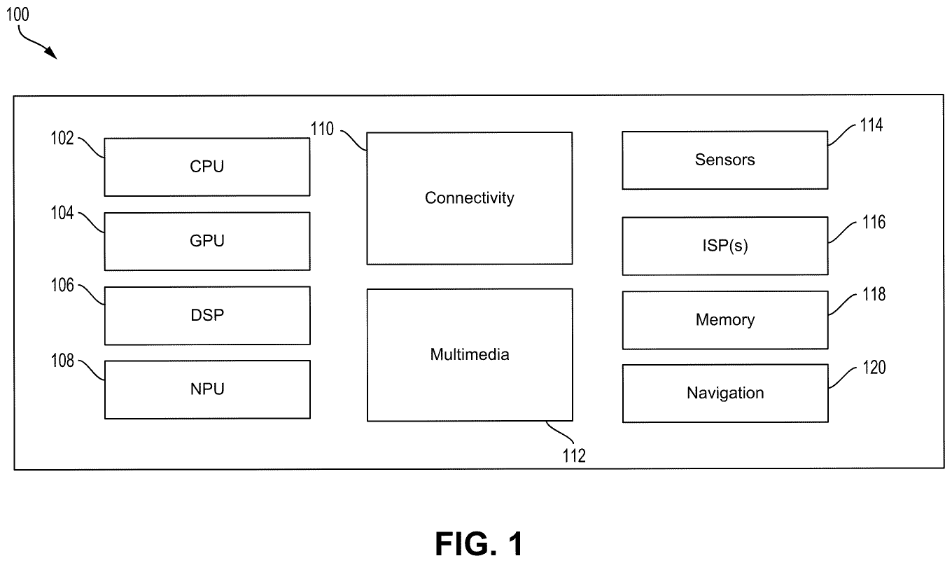

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118. The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system. The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform semantic image segmentation according to aspects of the present disclosure. In some cases, by using neural network architectures such as transformers and/or shifted window transformers in determining one or more segmentation masks, aspects of the present disclosure can increase the accuracy and efficiency of semantic image segmentation.

In general, ML can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IOT) devices, autonomous vehicles, service robots, among others. Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data. Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics. A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes, etc. Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

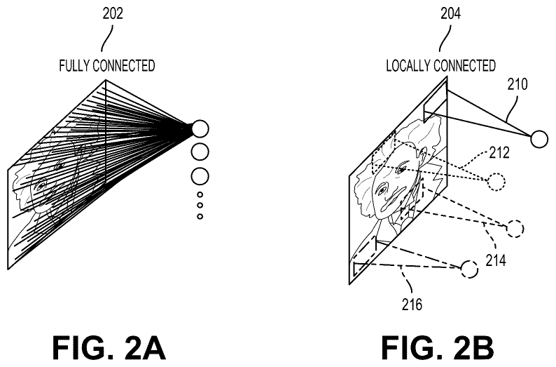

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, as the higher layer neurons in a given region may receive inputs that are tuned through training to the properties of a restricted portion of the total input to the network.

An ALB system (and/or other laser or LIDAR-based bathymetry system) can be carried by an aircraft that flies over a geographic area that is to be surveyed. For instance, an aircraft that includes an ALB system may fly at a pre-determined altitude above the ocean surface (and/or a pre-determined altitude relative to mean sea level, etc.). The ALB system can include a laser transmitter that is used to transmit a LIDAR swath having a width that is determined based at least in part on the pre-determined altitude flown by the aircraft. The LIDAR swath can include a plurality of individual laser footprints, which may be circular in nature and arranged in a line to form the LIDAR swath, or a single pulse diverged in the cross-track direction to produce a fan beam which forms the swath. The LIDAR swath may additionally be associated with a laser footprint width on the ocean floor. Reflections of the LIDAR swath may be received by an onboard receiver on the aircraft. For example, the onboard receiver and the laser transmitter may be included in the same ALB system.

The waveform(s) of both the outgoing and the returned (e.g., reflected) signals can be stored and used to generate ALB waveform data. In other words, ALB waveform data can include outgoing waveforms, return signal waveforms, and/or various combinations of the two. In some examples, ALB waveforms can be processed and analyzed to determine the topography of shallow coastal or inland waters. ALB waveforms may additionally be used to determine topography information of adjacent areas of land (e.g., land areas adjacent to the coastal or inland waters, etc.). ALB can be used to obtain high-accuracy and high-resolution nearshore and coastal mapping data. In some examples, ALB improves upon existing airborne bathymetric surveying techniques. For instance, many existing airborne bathymetric surveying techniques are associated with a trade-off between data density and depth penetration. ALB can be used to obtain mapping data with high data density and high depth penetration. In one illustrative example, an ALB system can obtain 25,000 range observations per second (e.g., 25 kHz sample rate) while also achieving a 3-Secchi disk depth penetration (e.g., which is a measure of water transparency or turbidity). In some cases, the resulting high-resolution bathymetry data obtained using an ALB system can be comparable to the bathymetry data obtained using multibeam echosounder systems. In some examples, an ALB system can be deployed to obtain mapping data on its own. In some aspects, an ALB system can be deployed in combination with one or more additional remote sensing systems, such that various bathymetric, topographic, and/or imagery data collection needs can be met using a single/same airborne mission. For example, an ALB system may be deployed in combination with topographic lidars, hyperspectral cameras, etc. The respective sensor data collected using the additional remote sensing systems may, in some cases, be combined or otherwise integrated with ALB waveform data generated by the ALB system. Existing approaches to processing bathymetry data (e.g., including ALB waveforms) are often based on performing a one-dimensional (1D) regression, in which a single independent variable is mapped to a single dependent variable. It can be computationally complex to generate mapping data such as point clouds based on applying a 1D regression to ALB waveform data. Additionally, the resulting mapping data may be prone to significant noise artifacts. A noise artifact can be an erroneous detection of a feature in the ALB waveform data (e.g., an erroneous detection of the water surface or other bathymetric feature, at a location where the feature does not exist). Many existing techniques for processing ALB waveform data are applied directly on the ALB waveform itself, as a signal processing operation. For example, existing approaches to processing ALB waveform data are often based on modelling the response curve of the ALB waveform to determine one or more bathymetric measurements (e.g., determined as a 1D regression problem).

In some aspects, a trained ALB segmentation machine learning network can be used to generate mapping data (e.g., including high resolution points clouds) based on applying a multi-dimensional, machine-learning based regression approach to ALB waveform data. In some aspects, mapping data may also be referred to herein as “surveying data.” For example, a trained ALB segmentation machine learning network can utilize spatiotemporal information associated with ALB waveform data to perform improved feature detection (e.g., improved detection and/or classification of features such as the water surface, seabed, topographic, geological, environmental features etc., that are represented in the ALB waveform(s)). In some cases, the trained ALB segmentation machine learning network can utilize multiple inputs of spatial information rather than spatiotemporal information (e.g., the temporal dimension can be replaced with multiple different inputs in the spatial dimension). In some examples, additional feature detection may be performed to detect or otherwise identify one or more features related to safety and/or navigational hazards. For instance, additional feature detection may be performed to detect or identify features such as shipwrecks, underwater debris, etc. Specific applications related to water systems but also environmental data sets such as seagrass observations/studies and also risk mitigation data sets such as UXO (unexploded ordinances) detection and monitoring of mammals, marine mammals and/or fish populations, etc.

In some cases, the trained ALB segmentation machine learning network can be used to identify multiple principal features in the ALB waveform data simultaneously. Rather than modeling ALB waveform response curves or performing other signal processing operations on the ALB waveform directly, the trained ALB segmentation machine learning network can encode ALB waveform data using a rasterized (e.g., pixel-based) representation of the lidar bathymetry returns from an ALB system. A raw ALB waveform is a time log of the interaction between the lidar laser pulse and its environment (e.g., the environment being surveyed or mapped), with each discrete sample time associated with a corresponding amplitude measurement (e.g., a corresponding intensity of the return signal).

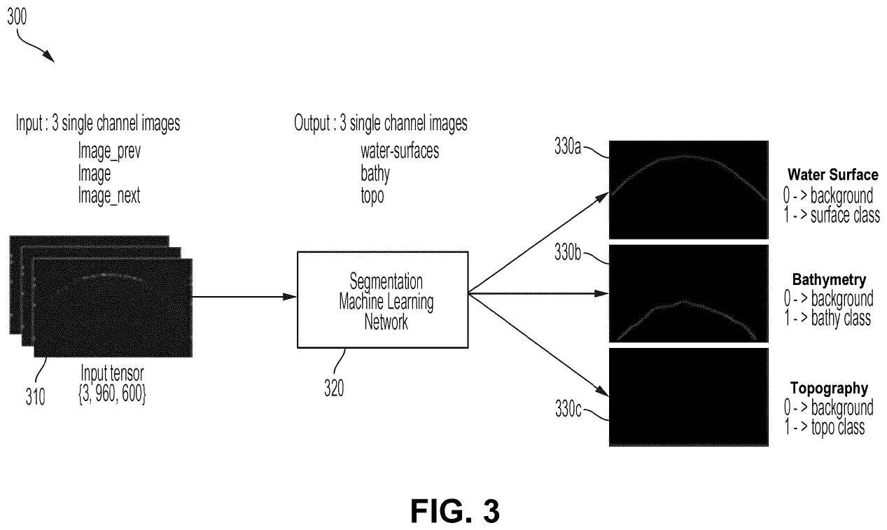

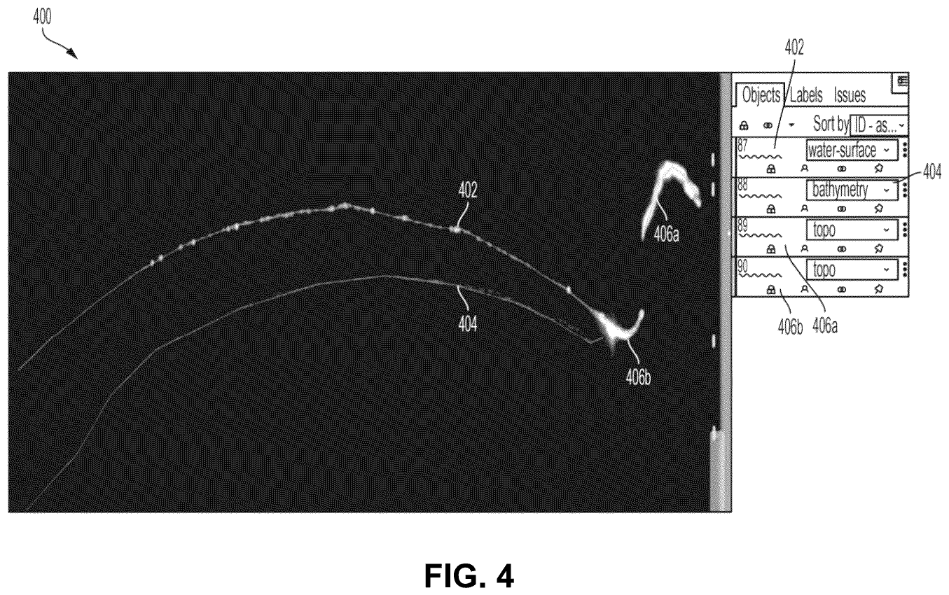

The rasterized representations of lidar bathymetry returns (e.g., ALB waveforms) can comprise a two-dimensional grid of pixels, with each pixel being associated with an intensity value. For instance, FIG. 4 depicts an example rasterized representation 400 of a lidar bathymetry return, wherein each (x, y) pixel location is associated with a corresponding intensity value. In the grayscale depiction of FIG. 4, a lower intensity value is represented as a darker black color, and a higher intensity value is represented as a lighter black (or white) color. Based on the rasterized representations of lidar bathymetry returns, multiple principal features can be detected simultaneously for a given ALB waveform or ALB waveform data input. For example, FIG. 3 is a diagram 300 illustrating an example of a bathymetry waveform (e.g., ALB waveform) segmentation task performed using a segmentation machine learning network. As illustrated, a segmentation machine learning network 320 can receive as input one or more rasterized ALB waveform representations 310, perform semantic segmentation (e.g., image segmentation), and generate as output a plurality of segmentation masks 330a-c that each correspond to a particular feature or classification within the ALB data.

In some cases, the input rasterized ALB waveform representations 310 (e.g., also referred to as rasterized ALB frames and/or lidar frames) can be obtained as a single, multi-channel tensor. For example, each channel of the multi-channel tensor can represent a different rasterized ALB frame. In one illustrative example, the multi-channel input tensor can be a three-channel tensor, with one channel representing a current rasterized ALB frame/ALB frame of interest, one channel representing an immediately preceding rasterized ALB frame, and one channel representing an immediately subsequent rasterized ALB frame. For example, a three-channel input tensor can include a first channel that represents the rasterized ALB frame for time t−1, a second channel that represents the rasterized ALB frame for time t, and a third channel that represents the rasterized ALB frame for time t+1. In some examples, the t−1, t, and t+1 frames may be separated by a fixed or constant amount of time. Each channel of the input 310 can have the same dimensions (e.g., the rasterized ALB frames generated for each time step can have the same dimensions). For instance, as illustrated, the input 310 can comprise a tensor having dimensions of (3, 960, 600), indicating that the input tensor 310 includes three channels (e.g., t−1, t, t+1), each channel representing a rasterized ALB frame having dimensions of 960 pixels×600 pixels. It is noted that these values are provided for purposes of example, and that various other input channel and/or pixel dimensions may also be utilized without departing from the scope of the present disclosure.

The multiple rasterized ALB frames included in the multi-channel tensor input 310 can be spatially and temporally adjacent. For example, the multiple rasterized ALB frames can be temporally adjacent based on being obtained as consecutive rasterized ALB frames in time (e.g., t−1, t, and t+1 are consecutive in time). When the time step between consecutive rasterized ALB frames is small, at least some spatial overlap will additionally be present between a given pair of consecutive rasterized frames. For example, the geographic area that is mapped by the ALB system at time/will include at least a portion of the geographic area that was previously mapped by the ALB system at time t−1 (with the amount of overlap based at least in part on the velocity and trajectory of the aircraft used to collect the ALB data, and the sampling rate associated with generating each rasterized ALB frame). In this manner, the multi-channel input tensor 310 provided to the segmentation machine learning network 320 can be seen to include multiple spatiotemporally adjacent representations of rasterized ALB frames.

The segmentation machine learning network 320 can be implemented using various machine learning models and/or architectures. For example, the segmentation machine learning network 320 can be implemented using one or more neural networks, transformers (e.g., vision transformers), deep learning models, etc. In some examples, the segmentation machine learning network 320 can be implemented using (or otherwise based on) a variety of segmentation models and/or ML architectures can also be utilized (e.g. Lite Reduced Atrous Spatial Pyramid Pooling (LR-ASPP) segmentation model from MobileNetv3). In some examples, the segmentation machine learning network 320 can implement an encoder-decoder architecture, in which a plurality of features are generated based on the set of rasterized ALB frames 310 received as input. For example, the rasterized ALB frames 310 can be provided to one or more encoders, which generate as output a plurality of features or embeddings corresponding to the rasterized ALB frames. In other examples, the segmentation machine learning network 320 can implement a segmentation decoder architecture, without including an encoder, in which case the input 310 can include features that were previously generated or determined for the rasterized ALB frames (e.g., input 310 can be obtained as a multi-channel tensor of features generated for the rasterized ALB frames). For example, the segmentation machine learning network 320 can include or otherwise implement a segmentation decoder, such as LR-ASPP.

A segmentation decoder included in or otherwise implemented by the segmentation machine learning network 320 can generate one or more segmentation masks based on receiving as input the plurality of features corresponding to the rasterized ALB frames 310. As mentioned previously, each segmentation mask can be generated to correspond to a given classification (e.g., segment classification) that is determined for the rasterized ALB frames of input 310. For example, when segmentation machine learning network 320 is trained to identify three principal features from an input rasterized ALB frame, the output of segmentation machine learning network 320 can include three different segmentation masks, one for each of the three principal features. In one illustrative example, where the segmentation machine learning network 320 is trained to identify water surface, seabed, and topographic features, the segmentation machine learning network 320 can generate as output a first segmentation mask 330a corresponding to detected water surface features in the input rasterized ALB waveform(s) 310, a second segmentation mask 330b corresponding to detected bathymetric (e.g., seabed) features in the input rasterized ALB waveform(s) 310, and a third segmentation mask 330c corresponding to detected topographic features in the input rasterized ALB waveform(s) 310.

In some aspects, the output 330 of segmentation machine learning network 320 can be a multi-channel tensor, with each channel of the multi-channel tensor comprising a single channel segmentation mask indicative of the detection of a particular feature in the input rasterized ALB waveform(s) 310. As illustrated, when the detected feature are the three principal features water surface, seabed, and topography, the output of segmentation machine learning network 320 can be a three-channel tensor that includes the three segmentation masks 330a, 330b, 330c described above. In some examples, the input tensor 310 and the output tensor 330 can have the same dimensions. For instance, as illustrated in FIG. 3, the input tensor 310 and the output tensor 330 can both be three-channel tensors with each channel having pixel dimensions of 960×600. In some examples, the pixel dimensions of the output channels (e.g., of output tensor(s) 330a-c) can be different than the pixel dimensions of the input channels (e.g., of input tensor 310). In some cases, the output tensor(s) 330a-c can include a greater quantity of channels than the input tensor 310. The quantity of channels included in the output tensor(s) 330a-c can be the same as the quantity of unique features or segmentation classifications that are utilized. For example, if segmentation machine learning network 320 is trained to identify five different features for a given input rasterized ALB frame, the output tensor(s) 330a-c can be generated as a five-channel tensor (e.g., five channels representing five segmentation masks corresponding to the five detected features/segmentation classifications).

In some examples, each output segmentation mask 330a-330c can have the same pixel dimensions as the input rasterized ALB frame(s) 310, as mentioned above. In some aspects, an output segmentation mask can be generated to include a respective probability for each pixel (e.g., each (x, y) pixel location) included in an input rasterized ALB frame. For example, the output segmentation mask can include respective probabilities for each pixel included in the current (e.g., time t) frame of rasterized ALB data. In some aspects, inference can be performed based on an input of three frames (e.g., inference can generate an output tensor that includes three channels or frames corresponding to the three outputs 330a-c, based on receiving the input tensor 310 that also includes three channels or frames). In some cases, inference for a current frame/can be performed based on an input that includes the current frame/and further includes two adjacent frames (e.g., frame t−1 and frame t−2). In some examples, inference can be performed by using one or more duplicate frames to pad an input with extra frames such that the input includes a total of three frames. For example, inference can be performed based on obtaining a current frame t and generating two duplicated frames based on current frame t-inference can subsequently be performed on a 3-frame input comprising the current frame t and the two duplicate frames. Similarly, inference can be performed based on obtaining a current frame/and one adjacent frame (e.g., either t−1 or t+1) and duplicating one of the two obtained frames to thereby generate a 3-frame input for inference.

For example, the water surface segmentation mask 330a can include a probability that each pixel or pixel location represents a water surface feature or otherwise belongs to a water surface feature classification; the seabed segmentation mask 330b can include a probability that each of the same pixels or pixel locations represent a seabed feature or otherwise belong to a seabed feature classification; and the topography segmentation mask 330c can include a probability that each of the same pixels of pixel locations represent a topographical feature or otherwise belong to a topographical feature classification. In some aspects, the probability values associated with the respective pixels/pixel locations included in each of the segmentation masks 330a-c can be provided as continuous values (e.g., between 0 and 1, or other desired probability range). In some cases, the probability values associated with the respective pixels/pixel locations can be provided as binary probabilities, for example with a given pixel being assigned a probability of either ‘0’ (indicating that the pixel does not belong to the feature class represented by the given segmentation mask) or ‘1’ (indicating that the pixel does belong to the feature class represented by the given segmentation mask).

In some examples, the segmentation machine learning network 320 can generate as output the segmentation masks 330a-c to include continuous probability values or discrete/binary probability values. In some aspects, the segmentation machine learning network 320 can generate as output the segmentation masks 330a-c to include continuous probability values, and a subsequent or downstream thresholding operation can be applied to convert the continuous probability values to discrete/binary probability values. In one illustrative example, thresholding can be applied such that a pixel in a segmentation mask that has a probability that is less than 75% is assigned a probability value of ‘0’ and pixels with a probability greater than or equal to 75% are assigned a probability value of ‘1.’ Various other thresholding values and/or approaches may also be utilized without departing from the scope of the present disclosure. In some examples, segmentation mask pixels described above as being assigned a probability value of ‘0’ may additionally, or alternatively, be classified as belonging to a background class, wherein the background class is different than the feature class associated with a given segmentation mask (e.g., thereby permitting the easy downstream differentiation between pixels belonging to the feature class of the given segmentation mask and pixels that do not belong/are not of interest).

FIG. 4 is a diagram illustrating an example lidar frame 400 comprising annotated (e.g., labeled) rasterized ALB waveform data. As mentioned previously, the lidar frame 400 can be seen to depict a rasterized representation of ALB waveform data that includes a two-dimensional grid of pixels each having an intensity value (e.g., intensity of the ALB return signal or waveform). In the grayscale representation seen in FIG. 4, darker shaded pixels represent a lower intensity value with lighter shaded pixels representing a greater intensity value. Raw or unlabeled rasterized frames of ALB waveform data can be annotated (e.g., labeled) to generate one or more training data sets for training the segmentation machine learning network (e.g., such as the segmentation machine learning network 320 illustrated in FIG. 3). For example, the training of the segmentation machine learning network 320 can be implemented as a supervised machine learning task, using a plurality of annotated frames of rasterized ALB data (e.g., a plurality of annotated lidar frames). As the trained ALB segmentation machine learning network can be used to detect multiple features simultaneously, each of the multiple features for detection can be labeled in each annotated frame of rasterized ALB data. In one illustrative example, each annotated frame of rasterized ALB data (e.g., such as annotated frame 400) can be generated to include one or more labels for each feature/feature classification that is to be learned by the segmentation machine learning network 320. For example, continuing in the example in which the three principal feature classifications are water surface, seabed, and topographic features, the annotated frame of rasterized ALB data 400 can include one or more water surface feature labels 402, one or more seabed feature labels 404, and one or more topographic feature labels (shown here as the topographic feature labels 406a and 406b). A greater number of features or feature classifications for detection can be trained by including, in the annotated frames of rasterized ALB data, a corresponding one or more labels for each additional feature that is to be learned. For instance, the ALB segmentation machine learning network can learn to detect or otherwise identify features such as boats or buoys (e.g., which may be treated as sub-features or sub-classifications of the water surface feature/classification) by generating the annotated frames of rasterized ALB data to include labels for boats or buoys, respectively, when the corresponding return signature for a boat or buoy is present in a given rasterized ALB frame.

The rasterized frames of ALB data that are used to generate a training set of annotated rasterized frames of ALB data can be the same as or similar to the rasterized frames of ALB data that will be used during inference. For example, the training data and inference inputs can both comprise rasterized frames of ALB data that represent a three-dimensional (3D) section of ALB waveform data. These 3D sections of ALB waveform data can allow the ALB segmentation machine learning model to learn a better contextual understanding of the environment associated with the ALB waveform data-compared to existing approaches to processing ALB waveform data, which are based on 1D regression analysis of 1D sections of the lidar waveform, the trained ALB segmentation machine learning network associated with the systems and techniques described herein can generate improved segmentation masks based on at least in part on leveraging the enhanced spatiotemporal information encoded in the rasterized ALB waveform representations.

In some examples, a 3D section of ALB waveform data can be generated based on combining a plurality of 1D sections into a composite, 2D section. For example, a plurality of discrete lidar waveform signatures can be combined to generate a 2D image of stacked lidar waveform signatures (e.g., the rasterized frame 400 depicted in FIG. 4 can be seen as a 2D image of stacked lidar waveform signatures). A third dimension is introduced by performing the segmentation task as a 3D problem over multiple 2D images of stacked lidar waveform signatures (e.g., a multi-image stack of the 2D images of stacked lidar waveform signatures). For instance, a third dimension can be introduced by providing as input to the segmentation machine learning network 320 the multi-channel input 310, which includes a first 2D image of stacked lidar waveform signatures associated with a subsequent time t−1, a second 2D image of stacked lidar waveform signatures associated with a current time t, and a third 2D image of stacked lidar waveform signatures associated with a subsequent time t+1. As such, the ALB waveform processing and analysis can be performed by the trained ALB segmentation machine learning network described herein as a 3D feature detection task implemented over a multi-channel input 310.

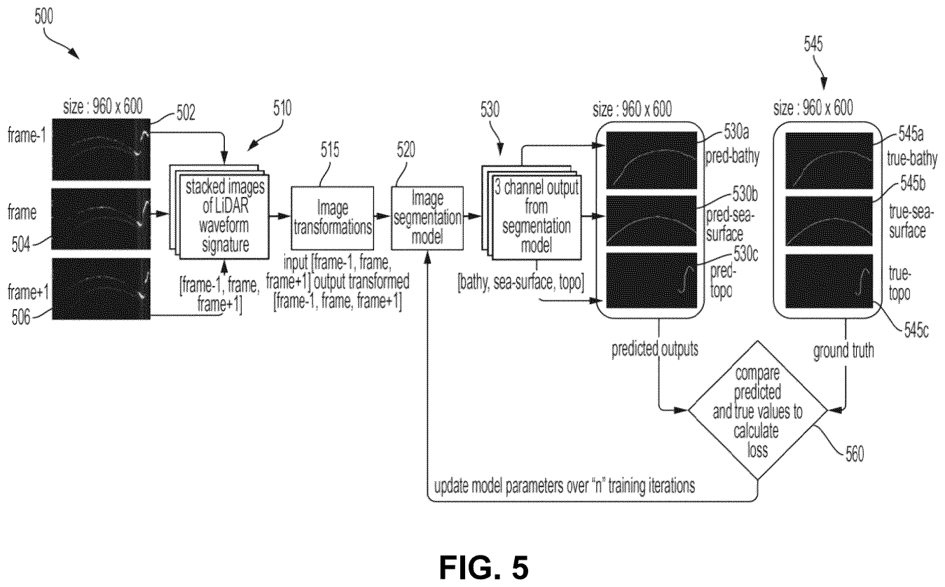

FIG. 5 is a diagram illustrating an example architecture 500 that can be used to train a bathymetry waveform (e.g., ALB waveform) segmentation machine learning network. In some aspects, the example training architecture 500 can include an image segmentation model 520 that is the same as or similar to the segmentation machine learning network 300 of FIG. 3. As illustrated, the example training architecture 500 can receive a training data input 510, comprising a set of stacked images of lidar waveform signatures. In some cases, the set of stacked images of lidar waveform signatures can be the same as or similar to that described above, in which multiple 2D rasterized representations of lidar waveform data are obtained for consecutive time instances. In particular, the example of FIG. 5 depicts a training data input 510 that includes a first frame (e.g., previous frame) of rasterized lidar waveform (e.g., ALB waveform) data 502 that is associated with a previous time step t 1, a second frame (e.g., current frame) of rasterized lidar waveform data 504 that is associated with a current time step t, and a third frame (e.g., subsequent frame) of rasterized lidar waveform data 506 that is associated with a next or subsequent time step t+1. In one illustrative example, the multiple frames of rasterized lidar waveform data 502-506 that are included in the training data input 510 can be spatiotemporally overlapping and/or adjacent frames, as also described above.

In some examples, the set of stacked images of lidar waveform signatures 502-506 included in the training data input 510 can be provided to an image transformation engine 515. The image transformation engine 515 can implement one or more image transformation operations, one or more image augmentation operations, one or more pre-processing operations, etc. For example, image transformation engine 515 can receive input images 502-506 that are represented as 16-bit image data and convert the 16-bit image data to 32-bit floats. In some cases, image transformation engine 515 can perform augmentation and/or transformation operations that can include, but are not limited to, increasing or decreasing the brightness and/or contrast of some (or all) of the respective images included in the training data inputs 510 used during a given training data iteration. In some cases, the augmentation and/or transformation operations can be applied randomly, such as based on a random selection of the lidar waveform training images to which augmentation/transformation will be applied, a random selection of the particular augmentation/transformation operation(s) to apply to the selected lidar waveform training images, a random selection of the directionality and/or magnitude of the augmentation/transformation operation(s) to apply to a selected lidar waveform training image, etc.

In addition to increasing or decreasing brightness, contrast, etc., of various input lidar waveform training images (e.g., such as the input lidar waveform training images 502, 504, 506), the image transformation engine 515 can additionally, or alternatively, flip or mirror input lidar waveform training images in the horizontal direction (e.g., along the horizontal, x-axis); can apply a random shift or crop (e.g., up to 10% of image size) in the horizontal and/or vertical directions; can apply a random rotation (e.g., up to 5 degrees) in the clockwise or counterclockwise directions); etc. Based on applying the one or more augmentation/transformation operations to some (or all) of the respective lidar waveform training images utilized during a given training iteration, the size of the training data set can be increased (e.g., increase the quantity of unique training data points/images), as an augmented or transformed image can provide a separate training data point from the original image provided to the image transformation engine 515. The use of augmented or transformed images generated by the image transformation engine 515 may additionally be seen to improve the resilience of the trained segmentation machine learning network 520 to small variations in the input lidar waveform (e.g., ALB waveform) data, as the image augmentation and transformation operation applied by image transformation engine 515 may be similar to the natural variation that can be observed across various lidar waveform datasets. As illustrated, the original input 510 comprising the annotated and rasterized training ALB frames 502, 504, 506 can be provided as input to the image segmentation model 520. Additionally, or alternatively, a given training iteration can include some (or all) of the augmented training frames generated by the image transformation engine 515. As mentioned previously, the image segmentation model 520 can be the same as or similar to the segmentation machine learning network 320 illustrated in FIG. 3.

In some aspects, each annotated frame of rasterized ALB data (e.g. 502, 504, 506 illustrated in FIG. 5; 400 illustrated in FIG. 4; etc.) can be annotated (e.g., labeled) using one or more polylines. A polyline is a continuous line that includes one or more connected straight line segments, which, together, form a shape. For example, each of the labeled features 402, 404, 406a, 406b can be represented as a polyline that is indicative of the position of the respective feature within the annotated frame of rasterized ALB data 400. Training can be performed by generating a plurality of ground truth segmentation masks (e.g., one for each feature classification represented in a given annotated frame of rasterized ALB data) and determining a difference (e.g., using one or more loss functions) between a segmentation mask output generated by the segmentation machine learning model and the corresponding ground truth segmentation masks.

In particular, during a training iteration, the image segmentation model 520 can generate as output a plurality of segmentation masks 530 (e.g., also referred to as a stack of segmentation masks). As illustrated, the plurality of segmentation masks 530 can include an output segmentation mask generated for each principal feature or classification that the image segmentation model 520 is being trained to detect. For instance, the plurality of segmentation masks 530 can include a first segmentation mask 530a generated corresponding to predicted bathymetry features (e.g., seabed/seafloor) identified in the current input ALB frame 504, a second segmentation mask 530b generated corresponding to predicted sea surface features identified in the current input ALB frame 504, and a third segmentation mask 530c generated corresponding to predicted topography features identified in the current input ALB frame 504. Recalling that the current input ALB frame 504 is obtained as an annotated frame of ALB training data (e.g., such as the annotated frame 400 illustrated and described above with respect to FIG. 4), the image segmentation model 520 can be trained based on determining a loss 560 between each of the output segmentation masks 530a, 530b, 530c and the corresponding ground-truth (e.g., labeled) segmentation masks 545a, 545b, 545c, respectively. The ground-truth segmentation masks 545 can be obtained in associated with obtaining the input training ALB frame 504 to which the ground-truth segmentation masks 545 correspond.

In some cases, the loss 560 can be determined as a cross-entropy loss. In other words, one or more cross-entropy based loss functions can be used to perform training of the image segmentation model 520. In some examples, the loss function 560 can additionally, or alternatively, be implemented based on a dice loss and/or a binary cross-entropy loss (BCE). In one illustrative example, loss function 560 can be implemented as a single/combined loss function that combines a dice loss and a BCE loss function. In some cases, the image segmentation model 520 can be trained based on utilizing one or more error metrics during the training process and/or during various training iterations. For example, the one or more error metrics can include a mean intersection over union (mIOU) error metric, a mean intersection of length error metric, etc.

The image segmentation model 520 can be implemented using a neural network model or architecture, as noted previously. For example, the image segmentation model 520 can utilize a CNN architecture, amongst others. In some aspects, the image segmentation model 520 can be trained (e.g., as depicted in FIG. 5) without using pre-training. In other words, image segmentation model 520 can be trained according to the approach of FIG. 5, without utilizing a pre-trained model as the initial image segmentation model 520. In some examples, the loss function 560 can compare the ground-truth segmentation masks 545 to the training output segmentation masks 530a as generated directly by the image segmentation model 520. In some aspects, the training output segmentation masks 530a can be processed using a threshold operation and/or can be binarized after being output by the image segmentation model 520 (e.g., prior to being compared to the corresponding ground-truth segmentation masks 545 to determine the loss 560). For instance, where the ground-truth segmentation masks 545 classify each pixel as either a ‘0’ (e.g., not belonging to the feature classification associated with the given ground-truth segmentation mask) or a ‘l’ (e.g., belonging to the feature classification associated with the given ground-truth segmentation mask), the segmentation masks output by the image segmentation model 520 may first be processed using a threshold operation and subsequently binarized to a same form as the ground-truth segmentation masks 545 (e.g., suitable for determining the loss between the output and ground-truth masks).

As mentioned previously, the systems and techniques described herein can be used to provide automated training and/or training data generation (e.g., training data annotation information, training data labels, etc.) for an airborne lidar bathymetry (ALB) machine learning system, where the automated training and/or training data generation for the ALB machine learning system is implemented using multibeam echo sounding (MBES) information. In one illustrative example, the systems and techniques can automatically generate ALB segmentation training data based on using MBES data as a source of ground truth labeling information for bathymetry features that can be detected in ALB data. In some aspects, the systems and techniques can be used to perform inference to predict or detect the location of a seabed surface or other bathymetry features in one or more ALB data frames, for example based on using the trained machine learning network to generate one or more segmentation masks corresponding to features that are identified in or otherwise represented in one or more bathymetry waveforms. In some aspects, the systems and techniques can be used to generate one or more segmentation masks corresponding to features that are identified or otherwise represented in various other forms of structured data, other than bathymetry data. For example, the systems and techniques can generate one or more segmentation masks corresponding to features that are identified or otherwise represented in point cloud images or other image series, any vertical collection of data from a point cloud database or other point cloud data source, a 3D volume of data, including, but not limited to, multibeam information associated with a water column, 3D seismic data, side scan data (e.g., water column profile information combined with imagery of the seabed.

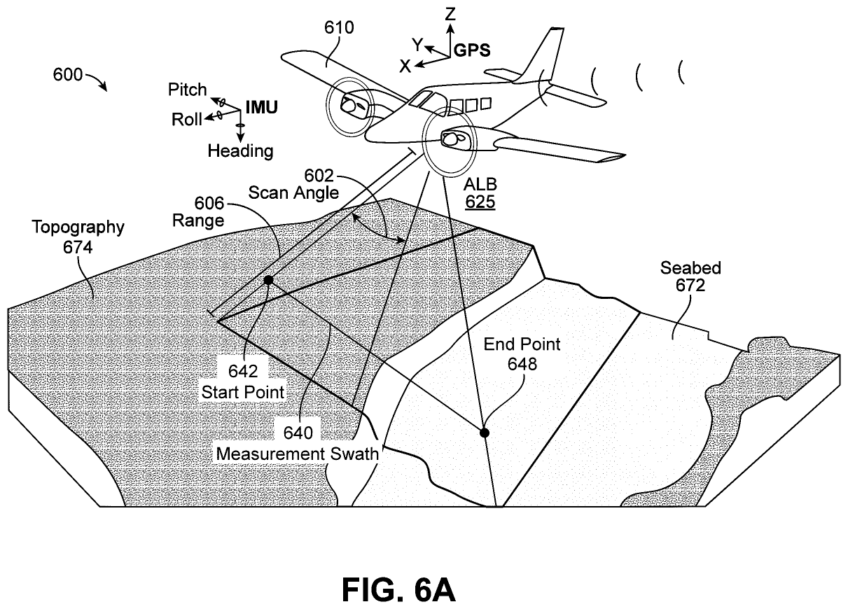

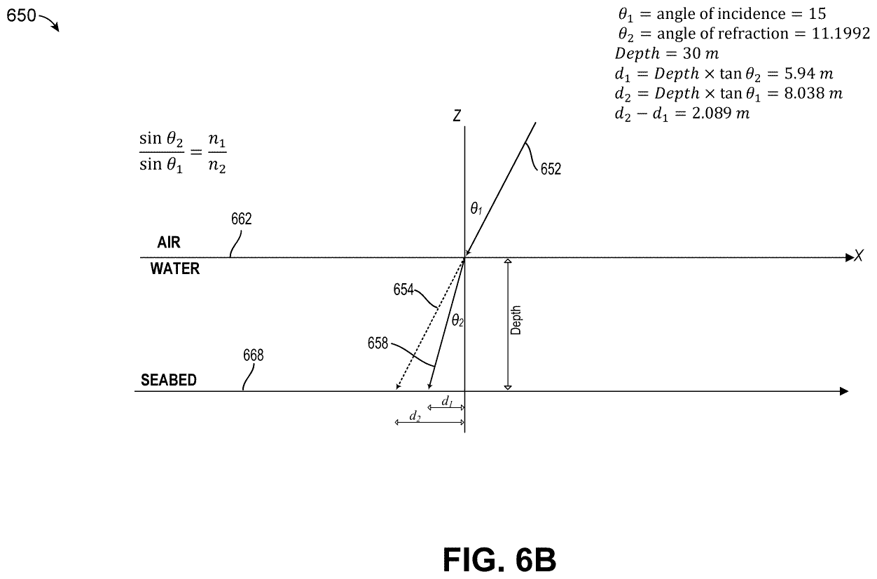

FIG. 6A is a diagram illustrating an example of an airborne light detection and ranging (lidar) bathymetry (ALB) system with a push-broom (e.g., linear) lidar scanning configuration 600, in accordance with some examples. Airborne lidar bathymetry is an active remote sensing technique that can be used to derive underwater topography (e.g., bathymetry) information based on detecting surface and bottom signals with a scanning laser (e.g., one or more lidar(s)). Laser pulses can be transmitted to penetrate the water column, and a reflection or return signal can be measured in response. For instance, an ALB 625 can comprise or otherwise include one or more lidars, and may be mounted, attached, coupled, etc., to an airborne vehicle 610, shown here as an aircraft, although it is noted various other airborne vehicles may also be utilized. As used herein, an “ALB system” may refer to the ALB 625 and/or may refer to a combination of the ALB 625 and the airborne vehicle 610.

ALB systems (e.g., such as the ALB 625, etc.) can be used for the rapid, large-scale mapping of coastal areas, rivers, lakes, and various other shallow water environments. As the aircraft or other airborne vehicle 610 flies over the surveyed area (e.g., the water body and surrounding land or shoreline areas of interest, etc.), the ALB 625 can emit rapid pulses of laser light towards the surveyed area. The laser pulses can reflect off of one or more surfaces within the surveyed area. For example, a laser pulse may reflect off of a terrain feature or other land-based topography 674, may reflect off of the water surface (not shown in the example of FIG. 6A), and/or may reflect off of the seabed 672 (e.g., the bottom or floor of the body of water). The ALB 625 can measure the round trip time (RTT) for each laser pulse to travel to a target within the surveyed area and reflect back to the ALB 625 sensor(s). Based on the time measurement or RTT determined for each reflected laser pulse, the ALB 625 can be used to calculate a range 606 (e.g., distance) from the ALB 625 to the target, where the target comprises a respective point lying on or otherwise along the current measurement swath 640. For example, the difference in return times between a water surface reflection and the seabed reflection can be used to determine the water depth at a given location.

The ALB system of FIG. 6A can be used to measure the depth and topography of water bodies within a surveyed area that is below the path of the airborne vehicle 610 through and above the environment. The ALB system can additionally be used to measure or determine information corresponding to the topography of the water surface and/or surrounding shoreline areas adjacent to the body of water. For example, the ALB 625 can be used to perform a plurality of lidar measurement scans to generate ALB measurements and/or data comprising a plurality of lidar frames that are each obtained corresponding to a respective measurement swath 640.

For example, the ALB 625 and/or ALB system of FIG. 6A can be configured with a push-broom lidar scanning configuration in which each lidar measurement scan (e.g., with each scan corresponding to the generating of one lidar frame with a plurality of individual lidar measurement points therewithin) is performed along a respective measurement swath 640. The measurement swath 640 can comprise a line extending between a start point 642 and an end point 648. The push-broom lidar scanning configuration can also be referred to as a linear lidar configuration. The measurement swath 640 can be perpendicular to the direction of travel of the aircraft 610, or may be oriented at various other angles relative to the direction of travel or nose of the aircraft 610. The angle of the measurement swath 640 relative to the direction of travel or the nose of the aircraft 610 can be configured by the attachment of the ALB 625 to the aircraft 610, and/or the relative angle or orientation (e.g., heading) between the ALB 625 and the aircraft 610 to which the ALB 625 is attached.

Position and orientation information can be determined using one or more sensors associated with the aircraft 610 and/or the ALB 625. The position and orientation information can be used to localize each lidar return to a particular location or coordinate within the surveyed area. For example, the aircraft or airborne vehicle 610 can include one or more positioning sensors or positioning systems (e.g., a global positioning system (GPS), a global navigation satellite system (GNSS), an inertial navigation system (INS), a dead reckoning navigation system, a visual odometry system, a celestial navigation system, a beacon-based navigation system, a laser-based navigation system, and/or a magnetic navigation system, etc.), which can be used to determine the corresponding position of the aircraft 610, and therefore the ALB 625, at the time each ALB measurement is taken.

For example, the plurality of individual lidar measurement points along the measurement swath 640 can be associated to the same position information of the aircraft 610, based on the plurality of individual lidar measurement points along the measurement swath 640 being performed at approximately the same point in time (e.g., the speed of the lidar sweeping through the scan angle 602 to perform respective lidar measurement points between the start point 642 and end point 648 of the measurement swath 640 is much greater than the forward speed of the aircraft 610, such that each individual lidar measurement point can be treated as having been performed with the same aircraft 610 GPS position, etc.).

The aircraft or airborne vehicle 610 can additionally include one or more orientation sensors or orientation systems (e.g., accelerometers, gyroscopes, inertial sensors, magnetic sensors, etc.) that can be used to determine the corresponding orientation of the aircraft, and therefore the ALB 625, at the time each ALB measurement is taken. For example, the aircraft 610 can include one or more IMUs, accelerometer, gyroscopes, or other inertial sensors, and/or may include an INS that can be used to determine orientation information such as a current pitch, roll, and/or heading of the aircraft 610 and therefore the ALB 625 at the time the ALB measurement corresponding to the measurement swath 640 is performed, etc.

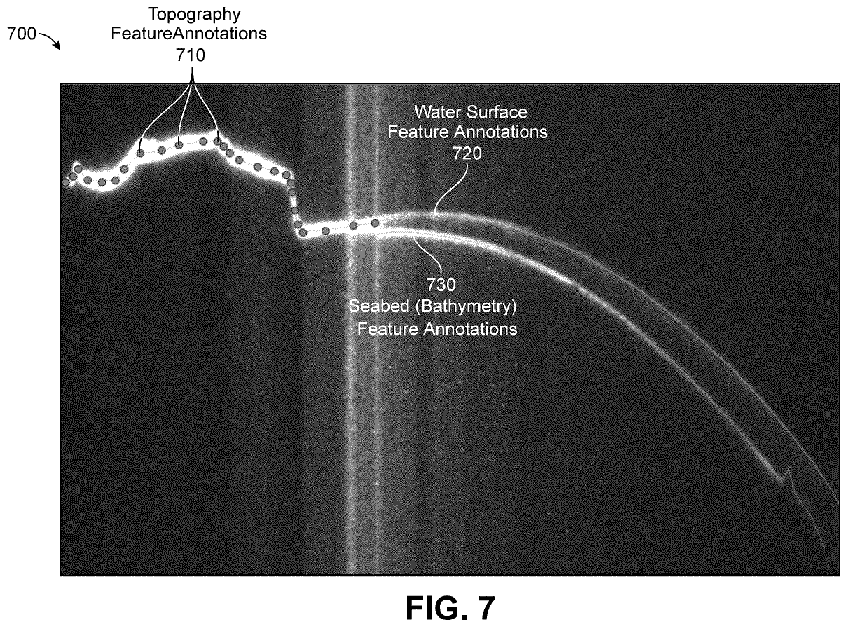

As noted previously, ALB data and/or ALB measurements can be obtained as range-angle data, where each ALB measurement is characterized by a beam angle 602 (also referred to as a scan angle or scan angle of incidence) of the emitted laser pulse from the ALB 625, and a calculated range 606 from the ALB 625 to a measurement point of a target lying along the measurement swath 640. In some aspects, the ALB 625 can perform a plurality of lidar measurements along the measurement swath 640, and can obtain a frame of lidar data that is the same as or similar to one or more of the lidar frames of FIGS. 3-5 described above. For example, the ALB 625 can obtain lidar frames comprising range-angle data that is the same as or similar to the range-angle lidar frame 310 of FIG. 3, the range-angle lidar frame 400 of FIG. 4, the range-angle lidar frames 502-506 of FIG. 5, the range-angle lidar frame 700 of FIG. 7, etc. The range-angle data of the lidar frames obtained by the ALB 625 of FIG. 6A can comprise a plurality of lidar measurement points, where each lidar measurement is associated with a different scan angle 602 of the ALB 625, and therefore a different point along the measurement swath 640 between the start point 642 and end point 648. Based on the measured RTT for the ALB 625 to receive a reflection of an emitted lidar laser pulse, each lidar measurement point is also associated with a respective range 606. The range 606 can be calculated for each one of the different scan angles 602/lidar measurement points along the measurement swath 640, where the calculated value of the range 606 represents the straight-line distance from the ALB to the particular measurement point on the measurement swath 640.

In some examples, the range-angle data of the ALB data or measurements can be associated with a range-angle coordinate system, where a horizontal axis corresponds to a scan angle of incidence (e.g., the scan angle/beam angle 602) along the measurement swath 640 of the ALB 625. For example, a single “scan” performed by the ALB 625 to generate one lidar frame (e.g., such as the lidar frames 310, 400, 502, 504, 506, 700, etc.) can comprise a plurality of lidar pulses emitted at different beam angles 602 along the single line representing the measurement swath 640. A vertical axis of the range-angle coordinate system can correspond to the calculated range or distance 606 to the target. In some aspects, based on the range/distance calculation being based on the RTT or elapsed time between emitting a pulse and receiving a corresponding reflection of the pulse, the range-angle coordinate system may also be referred to as a time-angle coordinate system.

In some embodiments, the systems and techniques described herein can be used to automate training data generation for training a segmentation machine learning network to identify seabed and/or bathymetry features from inputs comprising lidar frames or other ALB measurement data. In particular, the systems and techniques can be used to automate training data generation by automatically generating ground truth annotation information (e.g., labeling information) for a plurality of lidar frames, using a corresponding set of MBES data points to generate the annotation information for each respective lidar frame of the plurality of lidar frames.

In some aspects, the automatically generated training data can include bathymetry annotation information that is indicative of a ground truth location of the seabed within each lidar frame of a plurality of frames included in a set of training data for the ALB segmentation machine learning network. In some embodiments, the bathymetry annotation information can be generated from MBES data of the same surveyed area or environment as the training data lidar frame that is being labeled. The bathymetry annotation information can comprise a polyline indicative of the ground truth seabed floor location at each lidar measurement point of the plurality of lidar measurement points include in a lidar frame. For example, the bathymetry annotation information can comprise a polyline indicating the ground truth seabed floor location at each measurement point along the measurement swath 640 of FIG. 6A, etc. In some embodiments, the automatically generated bathymetry annotation information can be the same as or similar to the seabed (e.g., bathymetry) feature annotations 730 of FIG. 7, described in further detail below.

In some embodiments, the automatically generated training data (and/or the bathymetry annotation information thereof) can be generated based on identifying a subset of corresponding MBES data points for each respective lidar frame, and performing a georeferencing process to transform between the MBES data and MBES coordinate space, to the ALB lidar frame and ALB coordinate space. For example, the corresponding MBES data points can be georeferenced to identify the respective lidar frame, and the MBES data can be transformed into a simulated lidar frame measuring the same seabed area and seabed features. The simulated lidar frame generated from projecting the MBES data points from a geodetic coordinate space into the angle-time coordinate space of the ALB system and ALB/lidar measurement frames can be used as ground truth annotation information for training an ALB segmentation machine learning network to identify bathymetry features for a broader set of given input lidar frames.

In some examples, the transformation between the MBES data in the (x, y, z) coordinate space and the lidar frame ALB data in the angle-time space can be implemented to include a refraction adjustment or a refraction compensation, based on simulation information that is calculated or otherwise determined for the refraction that occurs at the surface of the water above the seabed features being measured in the bathymetry data. In particular, the simulation information may be calculated or determined to correspond to the refraction of light (e.g., the lidar pulses from the ALB system) that occurs at the air-water interface between the water body being measured and the atmospheric environment in which the ALB system travels while performing the measurements.

Refraction is the redirection (e.g., bending) of a wave as the wave passes from a first medium into a second medium. This redirection corresponds to changes in the speed of light in different mediums, with the extent of the redirection being based further upon the angle of incidence of the light relative to the interface (e.g., boundary) between the first medium and the second medium. For example, light (e.g., such as the ALB lidar pulses contemplated herein) refracts or bends when passing into a denser medium, such as when light passes from air (a less dense medium) into water (a denser medium). In particular, ALB lidar pulses travel more slowly in a denser medium such as water. Accordingly, ALB lidar pulses can be emitted from an aircraft with an ALB system, and may travel at a first speed through air. Upon hitting the surface of a body of water, the lidar pulses are slowed, and subsequently travel through the volume of the body of water with a second speed that is slower than the first speed. The change in speed of light in the denser medium provided by water (e.g., the slowing of light) further causes a change in the direction of propagation of the light, which bends (e.g., is refracted) towards the normal. The normal represents the line perpendicular to the boundary or interface between the first and second mediums associated with the refraction. For instance, in the example of lidar pulses (or other light waves) refracting at an air-water interface, lidar pulses that pass from air into water are slowed and refracted (e.g., bent) towards a normal that is perpendicular to the water surface.

More generally, the refraction of the lidar pulses and other light waves follows Snell's Law, which can be given as:

$$\frac{sin {θ}_{2}}{sin {θ}_{1}} = \frac{{n}_{1}}{{n}_{2}}$$

Here, θ₁ represents the angle of incidence, or the angle of the light traveling within the first medium (e.g., towards the interface, towards the second medium), measured relative to the normal of the interface/boundary between the first and second medium. The term θ₂ represents the angle of refraction, or the angle of the light traveling within the second medium (e.g., away from the interface, away from the first medium) measured relative to the same normal.

The term n₁ represents the index of refraction of light in the first medium, and n₂ represents the index of refraction of light in the second medium. The index of refraction, also referred to as the refractive index of a medium, is a dimensionless value that indicates and/or corresponds to the light bending ability of the given medium. For example, if the first medium is air, then n₁=1.00. If the second medium is sea water, n₂=1.34.

FIG. 6B is a diagram illustrating an example refraction scenario 650, in accordance with some examples. For instance, the example refraction scenario 650 of FIG. 6B depicts incident light 652 (e.g., a lidar pulse, etc.) as traveling within a first medium comprising air, before striking an air-water boundary 662 at an angle of incidence θ₁. The air-water boundary 662 can also be referred to as the air-water interface 662, and more generally comprises the boundary between a first medium (e.g., air) and a second medium (e.g., water).

The interaction of the incident light 652 with the air-water interface 662 causes the incident light 652 at angle θ₁ to refract and propagate through the water as the refracted light 658, at the angle of refraction θ₂. The refraction can be calculated according to Snell's Law, as reproduced above and within FIG. 6B. The refracted light 658 bends towards the normal defined in this example along the vertical, z-axis of the diagram. The refracted light 658 propagates through the water at the angle θ₂, where the propagation through the water corresponds to the light traveling, between the air-water interface 662 (e.g., which may be the surface of a body of water) and the seabed 668 (e.g., which may be the floor of the body of water).

In the example of incident light 652 comprising a lidar pulse from an airborne ALB system, the angle of incidence, θ₁, can be set as the scan angle used for launching the lidar pulse 652 into the air (e.g., the angle of incidence θ₁ can be equal to, or otherwise calculated based upon, the scan angle 602 illustrated in FIG. 6A, etc.). Accordingly, the angle of refraction θ₂ of the refracted lidar pulse 658 propagating within the body of water being surveyed can be calculated by using the known refractive indices of air and water, in combination with using the scan angle 602 as the angle of incidence θ₁. After being refracted at the air-water interface 662, the refracted lidar pulse 658 then travels in a straight line within the body of water, at the angle of refraction θ₂ that is bent towards the normal, and at the reduced speed due the increased density of water relative to air.

In the absence of refraction, an incident lidar pulse 652 hitting the water surface 662 at the angle of incidence θ₁ would continue to travel in a straight line within the water, until eventually intersecting with a seabed 668 location. The corresponding path of the incident lidar pulse 652 at the angle of incidence θ₁ and without refraction is depicted in FIG. 6B as the alternate path 654 (illustrated as a dashed line between the air-water interface 662 and the seabed 668, where the angle between alternate path 654 and the normal of the z-axis is equal to the angle of incidence θ₁). Given the depth or vertical displacement of the seabed 668 floor from the air-water interface 662 (e.g., the water depth at the surveyed point), and assuming no refraction, the horizontal displacement of the lidar pulse intersection with the seabed 668 floor is given as d₁=depth×tan θ₂. When accounting for the refraction that, in reality, does occur when the lidar pulse 652 passes from air into water at the boundary 662 comprising the surface of the body of water, the true horizontal displacement of the lidar pulse intersection with the seabed 668 floor is calculated as d₂=depth×tan 01. The difference in the location along the seabed 668 floor that is determined with refraction versus the location along the seabed 668 floor that is determined without considering refraction is equal to d₂−d₁=2.089 m for the example of the refraction scenario 650 of FIG. 6B, illustrating the improvements in accuracy that can be achieved by properly accounting and compensating for refraction interactions when using the systems and techniques described herein to move between the (x, y, z) MBES coordinate space and the angle-time lidar/ALB space.

Accordingly, the systems and techniques can transform between MBES data in an (x, y, z) coordinate system to lidar/ALB data in an angle-time coordinate system (e.g., range-angle coordinate system, etc.) based on a reverse simulation of the refraction at the air-water interface of the water surface. In particular, because the lidar pulses emitted by the ALB system travel through air and then through water, before intersecting a point on the seabed floor that corresponds to the measured bathymetry feature for a given lidar pulse (e.g., as described above), the MBES bathymetry data transformation can be implemented to reverse the refraction of light at the air-water boundary, to project the reflection of the lidar pulse off of the seabed floor and back up to the water surface, where the reflection is then refracted to bend away from the surface normal on the return path back to the receiver/transceiver on the ALB system. For example, back simulation can be performed or applied to the ground-truth MBES bathymetry information comprising a plurality of (x, y, z) coordinate points lying on the seabed surface.

For a given (x, y, z) MBES data point, Snell's Law can be used to calculate the angle that a lidar pulse would have had after passing from air into the body of water. The given MBES data point can be refracted in reverse, to simulate how a lidar pulse would have traveled in order to intersect the (x, y, z) coordinates of the given MBES data point on the seabed surface. For example, given the MBES depth coordinate, z, and the MBES geographic location (x, y), the angle and time values that would be measured by a lidar frame for an ALB bathymetry feature corresponding to the MBES data point can be calculated. The refractive indices n₁ and n₂ for air and water, equal to 1.00 and 1.34 as noted previously above, can be used to calculate the path that the lidar pulse would have followed after refracting through the water surface. The range and angle information measured by the ALB system in the lidar frame can be adjusted to compensate for the difference in the speed of light in air and water. As also noted above, light travels faster in air than in water, and accordingly, the time-of-flight (ToF) for the lidar pulse can be adjusted to account for the slower velocity of the lidar pulse in water and the faster velocity of the lidar pulse in air. For each MBES data point, the range 606 of FIG. 6A can be calculated based on an adjusted time of travel for the lidar pulse, where the adjusted time of travel is compensated based on the slower velocity in water and the faster velocity in air. For each MBES data point, a corrected angle (e.g., correction for scan angle 602) can be calculated based on the refraction of the lidar pulse when crossing the air-water interface at the surface of the body of water. In some cases, the adjusted range value may be calculated directly, and converted to an adjusted time of flight value as needed. In some examples, the adjusted time of flight value can be calculated directly, and converted to an adjusted range value as needed. The angle of incidence of a simulated lidar pulse corresponding to the MBES data point can be the calculated scan angle at which the lidar pulse would have hit the seafloor if it had been transmitted for the same point where the MBES data was collected.

The automatically generated bathymetry annotation information described herein can replace manually labeled training data that might otherwise be required in order to train the ALB segmentation machine learning network. In some cases, the automatically generated bathymetry annotation information can augment or extend a smaller amount of manually labeled training data for training the ALB segmentation machine learning network. For example, existing approaches to training an ALB segmentation machine learning network may use human domain experts to manually label thousands of images (e.g., frames) of ALB data, by having the training data labelers manually examine each ALB image and mark up the images with lines indicating where the topology, bathymetry, and water surface features are located within each ALB image. Thousands of labeled ALB images (e.g., labeled lidar frames) may be required for training the ALB segmentation machine learning network, and still thousands more labeled ALB images (different from the labeled ALB images used for training, i.e., unseen during training) may be required for validation during or after training.

The manual labeling approach can take several minutes per image, and may also result in inconsistent labeling and selection methods applied to the training data ALB images by different human labelers. Inconsistent labeling and selection can result in less accurate results from the corresponding trained machine learning model that is trained using the manually labeled, inconsistent ALB training data. It may be beneficial to automate the training process of ALB segmentation machine learning models, to improve the accuracy of the trained machine learning models (e.g., based on the automated bathymetry labeling disclosed herein having a higher degree of accuracy and consistency than manually labeled training data) and/or to reduce the number of person-hours required to generate the training data set (currently hundreds or thousands of person-hours, based on the size of the training data set being labeled and an approximate labeling time of several minutes per ALB image).

FIG. 7 is a diagram illustrating an example of an annotated frame of rasterized ALB data (e.g., an annotated lidar frame) 700, in accordance with some examples. In some aspects, the annotated lidar frame 700 of FIG. 7 can be the same as or similar to one or more of the annotated lidar frames of FIG. 4 and/or FIG. 5, described previously above (e.g., the same as or similar to one or more of the annotated frame 400 of FIG. 4; one or more of the annotated frames 502, 504, and/or 506 of FIG. 5; etc.).

The annotated lidar frame 700 can include topography feature annotations 710, indicative of the marked lidar measurement points corresponding to a location of topography features within the annotated lidar frame 780 data; can include water surface feature annotations 720, indicative of the marked lidar measurement points corresponding to a location of water surface features within the annotated lidar frame 700 data; and/or can include seabed (e.g., bathymetry) feature annotations 730, indicative of the marked lidar measurement points corresponding to a location of seabed (e.g., bathymetry) features within the annotated lidar frame 700 data. In some aspects, the annotations 710, 720, and/or 730 can comprise respective annotation polylines that are manually drawn or overlaid on the lidar frame 700 by a human reviewer (e.g., a human annotator, etc.).

In some aspects, the topography feature annotations 710 of FIG. 7 can correspond to the topography segmentation 330c of FIG. 3, the topography feature labels 406a of FIG. 4, the topography feature labels 406b of FIG. 4, the ground truth topography annotation/labels 545c of FIG. 5, etc. In some examples, the water surface feature annotations 710 of FIG. 7 can correspond to the water surface segmentation 330a of FIG. 3, the water surface feature labels 402 of FIG. 4, the ground truth water surface annotation/labels 545b of FIG. 5, etc. In some aspects, the seabed (e.g., bathymetry) feature annotations 730 of FIG. 7 can correspond to the bathymetry segmentation 330b of FIG. 3, the bathymetry feature labels 404 of FIG. 4, the ground truth bathymetry annotation/labels 545a of FIG. 5, etc.

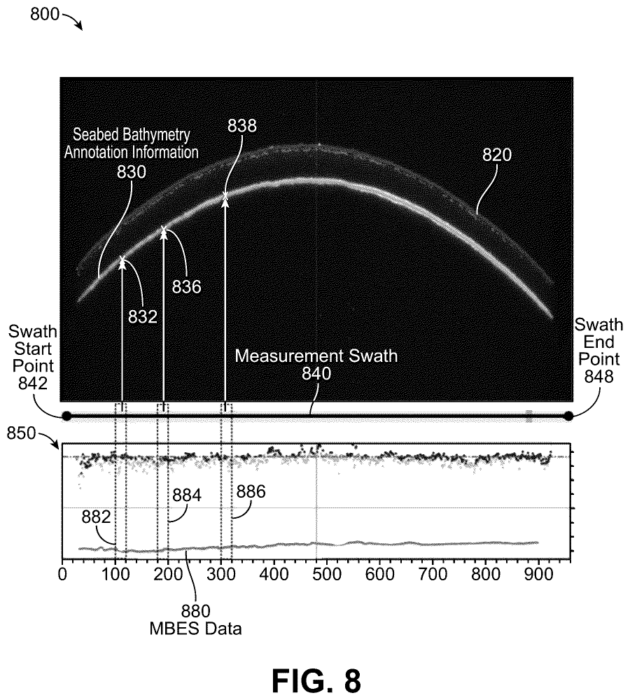

FIG. 8 is a diagram illustrating an example of automated ALB training data annotation information generated using a projection process between seabed (e.g., bathymetry) feature locations within multibeam echo sounder (MBES) bathymetry data and ALB/lidar frame data, in accordance with some examples. A lidar frame 800 can comprise a plurality of lidar measurement points that are obtained along a measurement swath 840 of an ALB system, with the horizontal axis of the lidar frame 800 representing an angle dimension (e.g., the scan/beam angle 602 of FIG. 6A, etc.) and the vertical axis of the lidar frame 800 representing a time/distance dimension (e.g., the range 606 of FIG. 6A, etc.). In some aspects, the lidar frame 800 of FIG. 8 can be obtained using an ALB system that is the same as or similar to the ALB system 600 of FIG. 6A and/or the ALB 625 of FIG. 6A, etc. In some examples, the measurement swath 840 of FIG. 8 can be the same as or similar to the measurement swath 640 of the ALB system 600/ALB 625 of FIG. 6A, etc. The measurement swath 840 can comprise a line of lidar measurement points obtained concurrently in time by the ALB system, and extending along the line defined between a swath start point 842 and a swath end point 848. In some aspects, the swath start point 842 of FIG. 8 can be the same as or similar to the swath start point 642 of FIG. 6A, and the swath end point 848 of FIG. 8 can be the same as or similar to the swath end point 648 of FIG. 6A. In some aspects, the lidar frame 800 of FIG. 8 can be the same as or similar to one or more of the lidar frames 310 of FIG. 3; 400 of FIG. 4; 502, 504, 506 of FIG. 5; and/or 700 of FIG. 7; etc.

The lidar frame 800 of FIG. 8 can be a lidar frame that is used for training of an ALB segmentation machine learning network. The lidar frame 800 includes a lidar return waveform corresponding to the reflections of lidar pulses off of the seabed floor (e.g., the lower of the two curves shown in the lidar frame 800), and includes a lidar return waveform 820 corresponding to the reflections of the lidar pulses off of the water surface (e.g., the upper of the two curves shown in the lidar frame 800).

Also shown in FIG. 8 is an example set of MBES data 850, obtained for the same surveyed area as the lidar frame 800, and corresponding to the same measurement swath 840 within the surveyed area. For example, the set of MBES data 850 can comprise a subset of MBES data points that are selected or identified from a larger plurality of MBES data points obtained previously for the entire surveyed area. The position and orientation information of the ALB system at the time the lidar frame 800 was obtained (e.g., the position and orientation information determined by the onboard sensors of the aircraft 610 or other airborne vehicle used to vary the ALB 625 of FIG. 6A, etc.) can be used in combination with the intrinsic parameters of the ALB/lidar unit to calculate the location of the measurement swath 840 in the same coordinate system as used by the MBES data 850.

For example, the MBES data 650 can be associated with an (x, y, z) coordinate system, a cartesian coordinate system, a geographic coordinate system, a spherical coordinate system, etc. In the example of FIG. 8, the MBES data 650 is shown using an (x, y, z) coordinate system, which is different from the angle-range (e.g., angle-time) coordinate system used by the lidar frame 800. In this example, the GPS coordinate of the aircraft 610 and ALB/lidar unit 625 can be obtained for the time when the lidar measurements underlying the lidar frame 800 were performed. The intrinsic parameters of the ALB/lidar unit 625 can include or indicate the tilt angle of the lidar beam relative to the aircraft, and the angular range between the maximum and minimum lidar beam/scan angles 602 can correspond to the swath start point 842 and swath end point 848. The geometry of the emitted beam used by the ALB/lidar unit 625 to perform the plurality of lidar measurement points along the measurement swath 840 can be combined with the GPS coordinate of the aircraft 610 and ALB/lidar unit 625 to calculate the (x, y, z) coordinate(s) corresponding to the swath start point 842, the swath end point 848, and/or some (or all) of the remaining lidar measurement points along the measurement swath line 840. By calculating a representation of the measurement swath 840 in the same (x, y, z) coordinate system as is used by the MBES data 850, the projected coordinates of the swath start point 842, the swath end point 848, and/or the measurement swath 840 can be used to identify or select a corresponding subset of MBES data points that best match or correspond to the lidar measurement points included in the lidar frame 800.

In some embodiments, the MBES data frame 850 is a subset of MBES data, selected from a larger set of MBES data obtained within the same surveyed environment as the lidar frame 800, that is identified or selected according to a comparison between the projected (x, y, z) coordinate information of the measurement swath line 840, and the respective (x, y, z) coordinate information of the MBES data points included in the larger MBES data set or MBES survey measurements. In particular, the MBES data frame 850 can include the subset of MBES data points 880 that correspond to the ground truth location of the seabed/seafloor surface along the measurement swath 840 of the given lidar frame 800.

Accordingly, in one illustrative example, the systems and techniques can be configured to project the corresponding subset of ground-truth MBES data 880 from the native (x, y, z) coordinate space of the MBES 850 into the native angle-time coordinate space of the lidar frame 800. For example, in some embodiments the projection of the ground-truth MBES data 880 into the angle-time coordinate space of lidar frame 800 can be performed based on the MBES and lidar/ALB coverage areas being overlapping, and the geographic start and end points of the lidar swath being known (e.g., the projection of the measurement swath start point 842 and end point 848 into the (x, y, z) coordinate space of the MBES frame 850, as described above).

In some embodiments, the length of the measurement swath 840 between the swath start point 842 and swath end point 848 can be divided into a number n of geographic points at a configured interval between the two endpoints 842, 848. In one illustrative example, the number of geographic points n can be equal to the number of pixels in the width of the ALB waveform of the lidar frame 800. For instance, if the ALB waveform/lidar frame 800 is 1024 pixels wide, then the number of geographic points n used for the division of the measurement swath 840 into equal intervals can be set as n=1024. Various other values for n may also be used, greater than or lesser than the horizontal width of the ALB waveform/lidar frame 800 in pixels. Various interval division schemes may also be utilized, including the creation of equally sized and/or spaced intervals along the measurement swath 840, or the creation of unequally sized and/or spaced intervals along the measurement swath 840, etc.

Each interval created along the length of the measurement swath 840 can be used to define a subset, group, or “bin” of the MBES data points that are included in the ground truth MBES bathymetry data 880 and correspond to a location that is included within the particular interval. For example, FIG. 8 illustrates a first subset 882 of the MBES data points 880 that are included within a first interval lying along the measurement swath 840, a second subset 884 of the MBES data points 880 that are included within a second interval lying along the measurement swath 840, a third subset 886 of the MBES data points 880 that are included within a third interval lying along the measurement swath 840, . . . , etc. The subsets 882-886 can be mutually exclusive subset (e.g., each MBES data point 880 is included in a maximum of one subset) in some examples. In other examples, the subsets 882-886 can be created such that an MBES data point included in the MBES data 880 may be included in zero, one, or multiple different subsets.

Each “bin” of a subset of the MBES data points 880 can be used to calculate a projected ground truth bathymetry annotation values for labeling the seabed location within the angle-time space of the lidar frame 800. For example, the subset of MBES data points included in each “bin” along the measurement swath 840 (e.g., the first subset 882, the second subset 884, the third subset 886, . . . , etc.) can be used to calculate or otherwise determine a representative set of one or more closest MBES data points for the geographic point location of the “bin” or interval. For example, each bin can correspond to an (x, y, z) coordinate of a geographic point at the center of the interval along the measurement swath 840. In some examples, the projection can comprise identifying the one MBES data point within the subset of the bin that has the minimum straight line distance to the (x, y, z) coordinate of the geographic center point of the measurement interval of the bin. In some examples, the projection can be based on identifying a set of closest geographic MBES points, such as geographic MBES points that are within a threshold distance to the geographic center point of the interval for each of the bins 882-886. When multiple geographic MBES points are identified as candidate MBES points (e.g., based on being within the threshold distance to the venter point of the bin, etc.), interpolation can be performed to generate a single, interpolated MBES value for the geographic center point coordinate of the interval used to define or divide each of the bins 882-886, etc., along the length of the measurement swath 840. Subsequently, the corresponding MBES value for each bin interval 882-886 can be projected from the geographic (x, y, z) coordinate system of the MBES data 880 into the angle-time coordinate system of the lidar frame 800.

For example, a corresponding projected annotation point can be projected into the angle-time space of the lidar frame 800 using the selected best match or interpolated MBES value for each one of the different bin intervals 882-886, etc., that is included in the n different intervals created by dividing the measurement swath 840 between its start and end points 842, 848. For example, the first bin interval 882 can have a best match or interpolated MBES value that is projected from (x, y, z) coordinate space of the MBES frame 850 into the angle-time coordinate space of the lidar frame 800 to thereby obtain the automatically generated ground-truth annotation point 832, indicative of a location of the seabed surface for the first bin interval 882 along the measurement swath 840. Similarly, the second bin interval 884 can have a best match or interpolated MBES value that is projected from (x, y, z) coordinate space of the MBES frame 850 into the angle-time coordinate space of the lidar frame 800 to thereby obtain the automatically generated ground-truth annotation point 836, indicative of a location of the seabed surface for the second bin interval 884 along the measurement swath 840. The third bin interval 886 can have a best match or interpolated MBES value that is projected from (x, y, z) coordinate space of the MBES frame 850 into the angle-time coordinate space of the lidar frame 800 to thereby obtain the automatically generated ground-truth annotation point 838, indicative of a location of the seabed surface for the third bin interval 886 along the measurement swath 840.

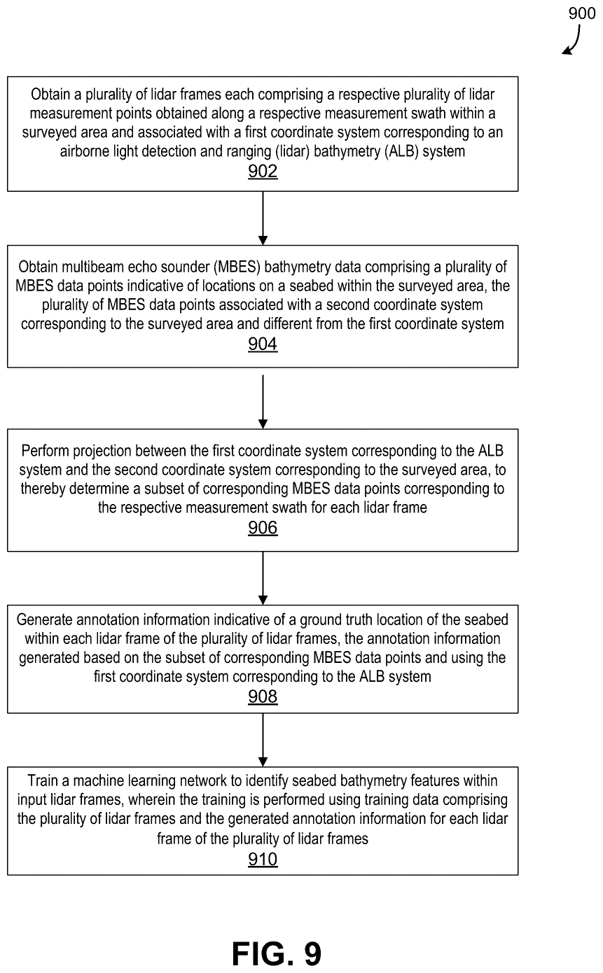

FIG. 9 is a flowchart diagram illustrating an example of a process 900 for automatic generation of training data for an airborne lidar bathymetry (ALB) machine learning system using multibeam echo sounding (MBES) data, in accordance with some examples. For example, the process 900 can correspond to the automatic generation of training data and/or annotation information for generating training data that can be used to train the segmentation machine learning network 320 of FIG. 3, 520 of FIG. 5, etc. In some aspects, the automatic generation of training data can be based on the seabed bathymetry annotation information 830 of FIG. 8 that is automatically generated based on the projection of the MBES data 880 of FIG. 8 from a coordinate system associated with an MBES survey into a coordinate system associated with an ALB survey. In some cases, the ALB survey and/or the ALB machine learning system can be associated with an ALB system such as the ALB system 600 and/or the ALB 625 of FIG. 6A.

In some aspects, at block 902, the process 900 can include obtaining a plurality of lidar frames each comprising a respective plurality of lidar measurement points obtained along a respective measurement swath within a surveyed area and associated with a first coordinate system corresponding to an airborne light detection and ranging (lidar) bathymetry (ALB) system. At block 904, the process 900 can include obtaining multibeam echo sounder (MBES) bathymetry data comprising a plurality of MBES data points indicative of locations on a seabed within the surveyed area, the plurality of MBES data points associated with a second coordinate system corresponding to the surveyed area and different from the first coordinate system. At block 906, the process 900 can include performing projection between the first coordinate system corresponding to the ALB system and the second coordinate system corresponding to the surveyed area, to thereby determine a subset of corresponding MBES data points corresponding to the respective measurement swath for each lidar frame of the plurality of lidar frames. At block 908, the process 900 can include generating annotation information indicative of a ground truth location of the seabed within each lidar frame of the plurality of lidar frames, the annotation information generated based on the subset of corresponding MBES data points and using the first coordinate system corresponding to the ALB system. At block 910, the process 900 can include training a machine learning network to identify seabed bathymetry features within input lidar frames, wherein the training is performed using training data comprising the plurality of lidar frames and the generated annotation information for each lidar frame of the plurality of lidar frames.

In some aspects, a process can include using the trained machine learning network of process 900 to perform inference for one or more inputs of lidar frames, lidar data or data points, and/or ALB data, etc. For example, a process of using the trained machine learning network of process 900 can include obtaining a plurality of lidar frames associated with an airborne light detection and ranging (lidar) bathymetry (ALB) system, each lidar frame of the plurality of lidar frames associated with a respective measurement swath within a surveyed area. The process of using the trained machine learning network can further include generating a plurality of features corresponding to each lidar frame of the plurality of lidar frames. The process of using the trained machine learning network can further include processing the plurality of features corresponding to each lidar frame using a trained ALB segmentation machine learning network, wherein processing the plurality of features using the trained ALB segmentation machine learning network includes performing inference to generate one or more segmentation masks indicative of predicted seabed feature locations detected in each lidar frame, and wherein the trained ALB segmentation machine learning network is trained using ground truth seabed feature location annotation information determined from multibeam echo sounder (MBES) bathymetry data.

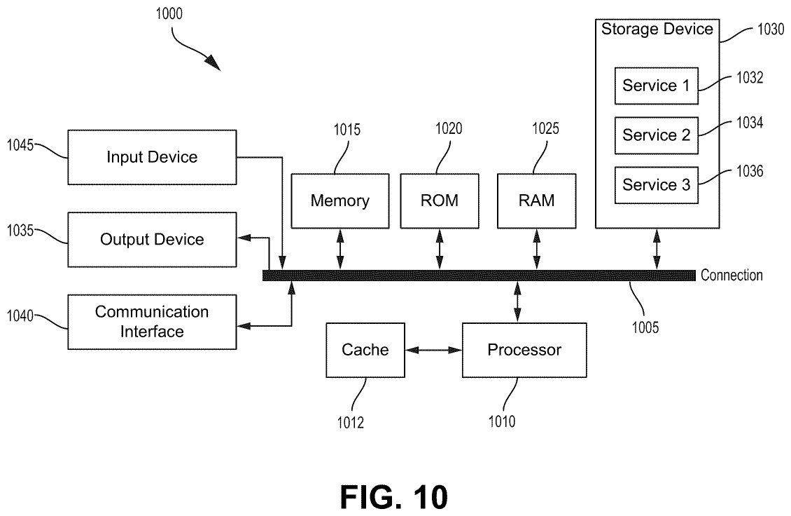

The operations of the process 900 may be implemented as software components that are executed and run on one or more processors (e.g., processor 1010 of FIG. 10 or other processor(s)). In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 900 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 900 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some aspects, computing system 1000 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 may include a cache 1015 of high-speed memory connected directly with, in close proximity to, or integrated as part of processor 1010.

Processor 1010 may include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some aspects, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

1. A method comprising:
obtaining a plurality of lidar frames each comprising a respective plurality of lidar measurement points obtained along a respective measurement swath within a surveyed area and associated with a first coordinate system corresponding to an airborne light detection and ranging (lidar) bathymetry (ALB) system;
obtaining multibeam echo sounder (MBES) bathymetry data comprising a plurality of MBES data points indicative of locations on a seabed within the surveyed area, the plurality of MBES data points associated with a second coordinate system corresponding to the surveyed area and different from the first coordinate system;
performing projection between the first coordinate system corresponding to the ALB system and the second coordinate system corresponding to the surveyed area, to thereby determine a subset of corresponding MBES data points corresponding to the respective measurement swath for each lidar frame of the plurality of lidar frames;
generating annotation information indicative of a ground truth location of the seabed within each lidar frame of the plurality of lidar frames, the annotation information generated based on the subset of corresponding MBES data points and using the first coordinate system corresponding to the ALB system; and
training a machine learning network to identify seabed bathymetry features within input lidar frames, wherein the training is performed using training data comprising the plurality of lidar frames and the generated annotation information for each lidar frame of the plurality of lidar frames.

2. The method of claim 1, wherein the first coordinate system includes:
a first coordinate dimension corresponding to a beam angle associated with one or more lidar scans of the ALB system, wherein different values of the beam angle are associated with different points along the respective measurement swath; and
a second coordinate dimension corresponding to a range from the ALB system, wherein different values of the range are associated with different distances from the ALB system.

3. The method of claim 1, wherein the second coordinate system is a Cartesian coordinate system, a geographic coordinate system, or a spherical coordinate system for a geographic region including the surveyed area.

4. The method of claim 1, wherein the respective measurement swath is a swath line extending between a first location within the surveyed area and a second location within the surveyed area, and wherein the respective plurality of lidar measurements are on the swath line.

5. The method of claim 1, wherein performing the projection to determine the subset of corresponding MBES data points for each respective lidar frame of the plurality of lidar frames includes:
calculating a georeferenced start and end coordinate for the respective measurement swath of the respective lidar frame, wherein the georeferenced start and end coordinates are determined within the second coordinate system;
generating a plurality of calculated points along a line between the georeferenced start and end coordinates within the second coordinate system, wherein the plurality of calculated points represent the lidar measurement swath in the second coordinate system, the plurality of calculated points adjusted based on refraction information determined corresponding to refraction of one or more lidar pulses at an air-water interface; and
comparing the plurality of calculated points to the plurality of MBES data points to determine a set of closest MBES data points for each one of the plurality of calculated points.

6. The method of claim 5, wherein generating the annotation information comprises:
interpolating between the set of closest MBES data points determined for each one of the plurality of calculated points representing the lidar measurement swath in the second coordinate system, to thereby generate an interpolated MBES data point lying on the lidar measurement swath; and
generating the annotation information to include the interpolated MBES data point as a ground truth location of a seabed bathymetry feature within the lidar frame, wherein the interpolated MBES data point is transformed from the second coordinate system to the first coordinate system using the determined refraction information corresponding to the refraction of the one or more lidar pulses at a water surface associated with the seabed within the surveyed area.

7. The method of claim 5, wherein the subset of corresponding MBES data points for the lidar frame comprises the sets of closest MBES data points determined for the calculated points representing the lidar measurement swath in the second coordinate system.

8. The method of claim 5, wherein the set of closest MBES data points includes MBES data points within a configured threshold distance from the calculated point.

9. The method of claim 5, wherein the set of closest MBES data points includes at least a first MBES data point having a shortest distance to the calculated point and a second MBES data point having a second shortest distance to the calculated point, the first and second MBES data points included in the MBES bathymetry data.

10. The method of claim 5, wherein a number of points included in the plurality of calculated points is equal to a number of horizontal pixels in the lidar frame.

11. The method of claim 5, wherein the plurality of calculated points is generated based on one or more of a configured separation interval or a configured maximum quantity.

12. The method of claim 5, wherein,
the respective lidar frame is obtained by the ALB system at a particular time; and
the georeferenced start and end coordinates are calculated based on a measured position of the ALB system at the particular time when the respective lidar frame was obtained by the ALB system, wherein the measured position of the ALB system is determined within the second coordinate system.

13. The method of claim 1, wherein a position of the ALB system in the second coordinate system is determined using one or more of a Global Navigation Satellite System (GNSS) or Global Positioning System (GPS) receivers coupled to the ALB system, or an inertial navigation system (INS) coupled to the ALB system.

14. The method of claim 1, wherein each lidar frame of the plurality of lidar frames comprises a rasterized frame of lidar bathymetry waveforms obtained along a linear measurement swath within the surveyed area.

15. The method of claim 1, wherein:
each lidar frame of the plurality of lidar frames includes at least a first subset of lidar measurement points corresponding to a water surface feature along the respective measurement swath within the surveyed area, and a second subset of lidar measurement points corresponding to a seabed bathymetry feature along the respective measurement swath within the surveyed area; and
training the machine learning network to identify seabed bathymetry features comprises training the machine learning network to identify the second subset of lidar measurement points within input lidar frames.

16. A method comprising:
obtaining a plurality of lidar frames associated with an airborne light detection and ranging (lidar) bathymetry (ALB) system, each lidar frame of the plurality of lidar frames associated with a respective measurement swath within a surveyed area;
generating a plurality of features corresponding to each lidar frame of the plurality of lidar frames; and
processing the plurality of features corresponding to each lidar frame using a trained ALB segmentation machine learning network, wherein processing the plurality of features using the trained ALB segmentation machine learning network includes performing inference to generate one or more segmentation masks indicative of predicted seabed feature locations detected in each lidar frame, and wherein the trained ALB segmentation machine learning network is trained using ground truth seabed feature location annotation information determined from multibeam echo sounder (MBES) bathymetry data.

17. A system comprising:
at least one processor; and
a memory storing instructions which when executed by the at least one processor, causes the at least one processor to:
obtain a plurality of lidar frames each comprising a respective plurality of lidar measurement points obtained along a respective measurement swath within a surveyed area and associated with a first coordinate system corresponding to an airborne light detection and ranging (lidar) bathymetry (ALB) system;
obtain multibeam echo sounder (MBES) bathymetry data comprising a plurality of MBES data points indicative of locations on a seabed within the surveyed area, the plurality of MBES data points associated with a second coordinate system corresponding to the surveyed area and different from the first coordinate system;
perform projection between the first coordinate system corresponding to the ALB system and the second coordinate system corresponding to the surveyed area, to thereby determine a subset of corresponding MBES data points corresponding to the respective measurement swath for each lidar frame of the plurality of lidar frames;
generate annotation information indicative of a ground truth location of the seabed within each lidar frame of the plurality of lidar frames, the annotation information generated based on the subset of corresponding MBES data points and using the first coordinate system corresponding to the ALB system; and
train a machine learning network to identify seabed bathymetry features within input lidar frames, wherein the training is performed using training data comprising the plurality of lidar frames and the generated annotation information for each lidar frame of the plurality of lidar frames.

18. The system of claim 17, wherein:
the first coordinate system includes a first coordinate dimension corresponding to a beam angle associated with one or more lidar scans of the ALB system, wherein different values of the beam angle are associated with different points along the respective measurement swath, and a second coordinate dimension corresponding to a range from the ALB system, wherein different values of the range are associated with different distances from the ALB system; and
the second coordinate system is a Cartesian coordinate system, a geographic coordinate system, or a spherical coordinate system for a geographic region including the surveyed area.

19. The system of claim 17, wherein, to perform the projection to determine the subset of corresponding MBES data points for each respective lidar frame of the plurality of lidar frames, the at least one processor is configured to:
calculate a georeferenced start and end coordinate for the respective measurement swath of the respective lidar frame, wherein the georeferenced start and end coordinates are determined within the second coordinate system;
generate a plurality of calculated points along a line between the georeferenced start and end coordinates within the second coordinate system, wherein the plurality of calculated points represent the lidar measurement swath in the second coordinate system, and wherein one or more of the start and end coordinate and the plurality of calculated points are adjusted between the first and second coordinate systems based on refraction compensation information corresponding to one or more lidar pulses refracting at a water surface within the surveyed area; and
compare the plurality of calculated points to the plurality of MBES data points to determine a set of closest MBES data points for each one of the plurality of calculated points.

20. The system of claim 19, wherein, to generate the annotation information, the at least one processor is configured to:
interpolate between the set of closest MBES data points determined for each one of the plurality of calculated points representing the lidar measurement swath in the second coordinate system, to thereby generate an interpolated MBES data point lying on the lidar measurement swath; and
generate the annotation information to include the interpolated MBES data point as a ground truth location of a seabed bathymetry feature within the lidar frame.
